(19) United States
(12) Patent Application Publication
(10) Pub. No.: US 2025/0054980 A1
(43) Pub. Date: Feb. 13, 2025

(54) CATHODE MATERIALS, CATHODES, BATTERIES, AND METHODS OF MAKING THEREOF

(71) Applicant: Din Ventures, LLC, Chicago, IL (US)

(72) Inventors: Rashed Din, Morton Grove, IL (US); Gurpreet Singh, Chicago, IL (US); Sai Aman Gopisetti, Chicago, IL (US)

(73) Assignee: Din Ventures, LLC, Chicago, IL (US)

(21) Appl. No.: 18/799,814

(22) Filed: Aug. 9, 2024

Related U.S. Application Data
(60) Provisional application No. 63/518,590, filed on Aug. 10, 2023.
(60) Provisional application No. 63/518,595, filed on Aug. 10, 2023.

(51) Int. Cl. H01M 4/587; C01B 32/184; C01B 32/198; H01M 4/02

(52) U.S. Cl. CPC H01M 4/587; C01B 32/184; C01B 32/198; C01B 2204/22; C01P 2002/52; C01P 2002/82; C01P 2002/85; C01P 2006/40; H01M 2004/028

(57) ABSTRACT

This invention relates generally to the field of energy storage, batteries, and cathodes, including cathode materials and methods to make the cathode materials comprising graphene and/or graphene with a plurality of dopants.

### CROSS-REFERENCE TO RELATED APPLICATIONS

The present application claims the benefit of U.S. Provisional Application No. 63/518,590 entitled “CATHODE MATERIALS, CATHODE, BATTERIES, AND METHODS OF MAKING THEREOF”, filed on Aug. 10, 2023, and U.S. Provisional Application No. 63/518,595 entitled “ELECTRODE MATERIALS, ELECTRODES, DEVICES, AND METHODS OF MAKING THEREOF”, filed on Aug. 10, 2023, the entire contents of which are entirely incorporated by reference herein.

### TECHNICAL FIELD

This invention relates generally to the field of energy storage, and more specifically to cathode materials and methods to make the cathode materials.

### BACKGROUND

Graphene, graphene oxide (GO), and reduced graphene oxide (rGO) exhibit high electrical conductivity, large surface area, and excellent mechanical properties. Electrodes composed of composites that combine carbon materials (e.g., graphene, GO, rGO, carbon nanotubes, or activated carbon) with metal oxides or conducting polymers have been developed to leverage the advantageous properties thereof. Metal oxides, such as MnO₂, RuO₂, and Co₃O₄, have been employed as electrode materials for supercapacitors and batteries due to their high specific capacitance and redox activity. Materials such as polyaniline, polypyrrole, and poly(3,4-ethylenedioxythiophene) (PEDOT) have been used as electrodes in energy storage devices and electrochemical sensors, owing to their high specific capacitance, good conductivity, and reversible redox activity.

There are, however, a variety of shortcomings to carbon containing electrode materials in the prior art, including inferior electrochemical properties, short shelf-life, insufficient doping efficiency, use of hazardous chemicals, limited binder compatibility, lack of versatility, lack of durability, and scalability/manufacturing challenges. Thus, there is a need in for new electrode materials with improved properties.

### SUMMARY

The present disclosure is directed to cathode materials, cathodes made from the cathode materials, and methods of making the cathode materials and cathodes. The present disclosure further relates to batteries made from the cathodes of the cathode materials.

In some aspects, the cathode material is a polyol reduced graphene with a plurality of dopants. In other aspects, the plurality of dopants are incorporated into the graphene.

In some aspects, the polyol may be ethylene glycol, glycerol, triethylene glycol (TEG), or combinations thereof. In one or more embodiments, the polyol is triethylene glycol.

In some aspects, the plurality of dopants include nitrogen, sulfur, boron, phosphorous, iron, or a combination thereof. In some embodiments, the plurality of dopants is a co-dopant comprising nitrogen and sulfur. Nitrogen may be derived from a nitrogen containing polyvinyl alcohol, polyacrylic acid, or combinations thereof. In some embodiments, the nitrogen is derived from chitosan. Sulfur may be derived from thioacetamide, sodium sulfide, elemental sulfur, thiourea, or combinations thereof.

In some aspects, the cathode material formula is CₓH_{y}O_{z}NₘSₙ, wherein x, y, z, m, and n are integers or decimal numbers; where x is about 1 to about 15, y is about 1 to about 20, z is about 0 to about 5, m is greater than 0 to about 15, and n is greater than 0 to about 15.

In some aspects, the cathode material formula is CₓH_{y}O_{z}NₘSₙ, wherein x, y, z, m, and n are integers or decimal numbers; where x is about 1 to about 10, y is about 1 to about 20, z is about 0 to about 5, m is greater than 0 to about 15, and n is greater than 0 to about 15.

In some aspects of the disclosure, the cathode material formula is CₓH_{y}O_{z}NₘSₙ, wherein x, y, z, m, and n are integers or decimal numbers; where x is about 2 to about 8, y is about 5 to about 15, z is about 2 to about 4, m is greater than 2 to about 4, and n is greater than 2 to about 4.

In other aspects, the cathode material formula is CₓH_{y}O_{z}NₘSₙ, wherein x, y, z, m, and n are integers or decimal numbers; where x is about 4 to about 6, y is about 5 to about 15, z is about 2 to about 4, m is greater than 2 to about 4, and n is greater than 2 to about 4.

In other aspects, the cathode material formula is CₓH_{y}O_{z}NₘSₙ, wherein x, y, z, m, and n are integers or decimal numbers; where x is about 2 to about 8, y is about 10 to about 12, z is about 2 to about 4, m is greater than 2 to about 4, and n is greater than 2 to about 4.

In one embodiment, the cathode material formula is C₆H₄N₂S. In another embodiment, the cathode material formula is C₅H₁₀O₃N₃S₃.

In some aspects of the disclosure, nitrogen to sulfur atomic ratio (N/S) is varied to optimize electrochemical performance of the cathode material in energy storage applications. In some embodiment, the N/S ratio ranges from about 1:1 to about 3:1.

In some embodiments, the cathode material has a specific capacity ranging from between 200 mAh/g to 750 mAh/g. In other embodiments, the cathode material has a specific capacity ranging from between 280 mAh/g to 450 mAh/g. In other embodiments, the cathode material has a specific capacity ranging from between 350 mAH/g to 600 mAh/g. In yet other embodiments, the cathode material has a specific capacity ranging from between 420 mAh/g to 750 mAh/g. In yet other embodiments, the cathode material has a specific capacity ranging from between 200 to 300 mAh/g.

In another aspect of the present disclosure, the cathode material has an energy density ranging from greater than 500 to 2500 Wh/kg. In some embodiments, the cathode material has an energy density ranging from 800 to 1500 Wh/kg. In other embodiments, the cathode material has an energy density ranging from 1000 to 2000 Wh/kg. In other embodiments, the cathode material has an energy density ranging from 1200 to 2500 Wh/kg. In one or more embodiments, the cathode material has an energy density ranging from 600 to 800 Wh/kg. In yet other embodiments, the cathode material has an energy density ranging from 510 to 700 Wh/kg.

Aspects of the present disclosure also relate to graphene doped with nitrogen and sulfur compositions. In some embodiments, the composition also includes a polyol. In some other embodiments, the composition further includes chitosan. In some embodiments, the graphene doped with nitrogen and sulfur is suitable for use as a cathode material.

Aspects of the present disclosure further relate to batteries made from the cathode materials described above. In some aspects of the disclosure, batteries described herein have a capacity retention of over 80%.

In some embodiments, batteries disclosed herein have a specific capacity ranging from between 200 mAh/g to 750 mAh/g. In some embodiments, batteries disclosed herein have a specific capacity ranging from between 280 mAh/g to 450 mAh/g. In other embodiments, batteries disclosed herein have a specific capacity ranging from between 350 mAh/g to 600 mAh/g. In other embodiments, batteries disclosed herein have a specific capacity ranging from between 420 mAh/g to 750 mAh/g. In other embodiments, batteries disclosed herein have a specific capacity ranging from between 200 to 300 mAh/g.

In some embodiments, batteries disclosed herein have an energy density ranging from greater than 500 to 2500 Wh/kg. In other embodiments, batteries disclosed herein have an energy density ranging from 800 to 1500 Wh/kg. In some embodiments, batteries disclosed herein have an energy density ranging from 1000 to 2000 Wh/kg. In some embodiments, batteries disclosed herein have an energy density ranging from 1200 to 2500 Wh/kg. In some embodiments, batteries disclosed herein have an energy density ranging from 600 to 800 Wh/kg. In some embodiments, batteries disclosed herein have an energy density ranging from 510 to 700 Wh/kg.

In some embodiments, batteries disclosed herein may be a coin cell battery. In some embodiments, batteries disclosed herein have a voltage ≥4.3 V, ≥4.2 V, ≥4.1 V, ≥4.0 V, ≥3.9 V, ≥3.8 V, or ≥3.7 V. In some embodiments, batteries disclosed herein have a voltage that is higher than 3.6 V lithium-ion coin cell batteries. In some embodiments, batteries disclosed herein battery have a 68-169% increase in energy density compared to 3.6 V lithium-ion coin cell batteries. In some embodiments, batteries disclosed herein have a capacity of ≥35 mAh, ≥36 mAh, ≥37 mAh, ≥38 mAh, ≥39 mAh, ≥40 mAh, ≥41 mAh, ≥42 mAh, ≥43 mAh, ≥44 mAh, ≥45 mAh, ≥46 mAh, ≥47 mAh, ≥48 mAh 49 mAh, ≥50 mAh. In some embodiments, batteries disclosed herein have a capacity from about 35 mAh to about 50 mAh.

Another aspect of the present disclosure relates to methods of producing a cathode for energy storage applications. The method involves forming a co-doped polyol reduced graphene material from graphene oxide, a polyol, and a plurality of dopants; mixing the co-doped polyol reduced graphene material and a binder material to form a homogeneous slurry; coating the homogeneous slurry onto a current collector material to form a coated electrode; drying the coated electrode in an oven to form a dried coated electrode; compressing the dried coated electrode to form an electrode with a specified density and a specified thickness; and cutting the electrode with the specified density and the specified thickness using a cutting tool to form the cathode for the battery.

In some embodiments of the method, the polyol includes ethylene glycol, glycerol, triethylene glycol, or combinations thereof.

In some embodiments of the method, the one or more dopants include nitrogen, sulfur, boron, phosphorous, iron, or a combination thereof. In other embodiments of the method, the co-dopant is nitrogen and sulfur. In some embodiments, the nitrogen is derived from a nitrogen containing polyvinyl alcohol, polyacrylic acid, thiourea, melamine, or combinations thereof. In other embodiments, the nitrogen is derived from chitosan. In yet other embodiments, the sulfur is derived from thioacetamide, sodium sulfide, elemental sulfur, thiourea, or combinations thereof.

In some embodiments, the binder material includes but is not limited to chitosan, alginate, cellulose derivatives, polyvinyl alcohol (PVA), carboxymethyl cellulose (CMC), or polyacrylic acid (PAA).

In some embodiments, the current collector material comprises aluminum, copper, stainless steel, or nickel.

In some embodiments, the specified thickness ranges from between about 150 μm to about 250 μm.

In some embodiments, the specified density ranges from between about 1.4 g/cm³ to about 1.8 g/cm³.

In some embodiments, the cutting tool comprises a disc cutter, punching tools, laser cutting, water jet cutting, or mechanical cutting tools including but not limited to rotary cutters or precision blades.

In some embodiments, reducing the graphene oxide to graphene and incorporation of dopants into the graphene occurs simultaneously.

In some embodiments of the method disclosed herein, the forming a co-doped polyol reduced graphene step includes forming a co-doped triethylene glycol reduced graphene material. In some embodiments, forming a co-doped triethylene glycol reduced graphene material includes the following steps: drying graphene oxide to form a dried graphene oxide with a moisture content of under 1 wt %; dispersing the dried graphene oxide in triethylene glycol by sonication to form a solution of graphene oxide in triethylene glycol; adding chitosan and thiourea to the solution of graphene oxide in triethylene glycol to form a mixture of chitosan, thiourea, and graphene oxide in triethylene glycol; adjusting the pH of the mixture to between 9 and 10; heating the mixture to a temperature in an inert atmosphere for a specified time to form a co-doped triethylene glycol reduced graphene solution; cooling the co-doped triethylene glycol reduced graphene solution; removing the co-doped triethylene glycol reduced graphene from the solution by diluting, centrifuging, and washing to form a co-doped triethylene glycol reduced graphene pellet; and drying the co-doped triethylene glycol reduced graphene pellet to obtain the co-doped triethylene glycol reduced graphene material.

In some embodiments, the temperature in the heating the mixture step ranges from about 270° C. to about 285° C.

### BRIEF DESCRIPTION OF THE FIGURES

FIG. 1 is a flowchart representation of an example method.

FIG. 2 is a flowchart representation of an example method.

FIG. 3A is a representative high resolution C1s XPS spectrum obtained from a co-doped triethylene glycol reduced graphene cathode material disclosed herewith.

FIG. 3B is a representative high resolution N1s XPS spectrum obtained from a co-doped triethylene glycol reduced graphene cathode material disclosed herewith.

FIG. 3C is a representative high resolution O1s XPS spectrum of co-doped triethylene glycol reduced graphene cathode disclosed herewith disclosed herewith.

FIG. 3D is a representative high resolution S2p XPS spectrum of co-doped triethylene glycol reduced graphene cathode materials disclosed herewith.

FIG. 3E is a representative XPS spectrum of co-doped triethylene glycol reduced graphene cathode materials disclosed herewith.

FIG. 4 is a representative XPS spectrum co-doped triethylene glycol reduced graphene cathode materials disclosed herewith.

FIG. 5 is a representative Raman spectrum of co-doped triethylene glycol reduced graphene cathode materials.

FIG. 6 shows representative line charts showing capacity retention and capacity fade over cycles according to some embodiments of the present disclosure.

FIG. 7 shows representative line charts showing coulombic efficiency and state of health over cycles according to some embodiments of the present disclosure.

FIG. 8 shows representative line charts showing battery capacity and charge time over cycles according to some embodiments of the present disclosure.

### DETAILED DESCRIPTION

The following description of the embodiments of the invention is not intended to limit the invention to these embodiments but rather to enable a person skilled in the art to make and use this invention.

In one aspect, this disclosure relates to a cathode material, method of making the cathode material, method of making a cathode from the cathode material, and use of the cathode. The cathode material of the present disclosure may be a doped polyol reduced graphene. The doped polyol reduced graphene may be used to develop more efficient, compact, and lightweight energy storage solutions, ultimately benefiting portable electronic devices, wearable technology, and small-scale energy storage industries.

### Cathode Material—Doped Polyol Reduced Graphene

The cathode material may include a doped polyol reduced graphene. The cathode material may be formed by reducing graphene oxide in the presence of a suitable reducing agent and solvent. The reducing agent and the solvent may be the same compound. Polyols may function as both reducing agents and solvents. Examples of suitable polyols include triethylene glycol (TEG), ethylene glycol (EG), glycerol, or combinations thereof.

The polyol reduced graphene of the cathode material of the present disclosure may be doped with one, two, or more dopants. Likewise, the polyol reduced graphene of the cathode material of the present disclosure may be doped a plurality of dopants. The electrochemical properties of the resulting cathode may be controlled by doping the polyol reduced graphene of the cathode material. The electrochemical properties include energy density, specific capacity, rate capability, cycling stability, or a combination thereof. For example, nitrogen doping may improve electronic conductivity. Furthermore, sulfur doping may enhance capacity by facilitating additional charge storage mechanisms.

In some aspects, the cathode material may be doped with two or more dopants. For example, the polyol reduced graphene may be doped with 2 dopants, 3 dopants, 4 dopants, or 5 dopants. The dopants may be incorporated into the graphene. Examples of suitable dopants include but are not limited to nitrogen, sulfur, boron, phosphorous, or various transition metals such as iron. In some embodiments of the cathode material, the polyol reduced graphene is co-doped with nitrogen and sulfur.

The particle size of the doped polyol reduced graphene of the cathode material ranges from about 100 nm to about 10 μm. For example, the particle size may be from about 150 nm to about 9.5 μm, about 200 nm to about 9.0 μm, 250 nm to about 8.5 μm, about 300 nm to about 8.0 μm, 350 nm to about 7.5 μm, about 400 nm to about 7.0 μm, 450 nm to about 6.5 μm, about 500 nm to about 6.0 μm, 550 nm to about 5.5 μm, about 600 nm to about 5.0 μm, 650 nm to about 4.5 μm, about 700 nm to about 4.0 μm, 750 nm to about 3.5 μm, about 800 nm to about 3.0 μm, 850 nm to about 2.5 μm, about 900 nm to about 2.0 μm, 950 nm to about 1.5 μm, or about 1 μm to about 1.25 μm. In another aspect, the particle size range is a wide range that includes sizes typical of both individual graphene sheets (usually on the order of 1 μm or less) and small aggregates or bundles of sheets (which may be from about 10 μm to about 100 μm, or larger).

In certain aspects, the energy density, specific capacity, and cycling stability of the doped polyol reduced graphene may be measured by analytical techniques including but not limited to cyclic voltammetry, galvanostatic charge/discharge cycling, and electrochemical impedance spectroscopy. In some aspects, the cathode materials exhibit increased energy density, higher specific capacity, and improved cycling stability relative to traditional cathode materials such as lithium cobalt oxide (LiCoO₂) or lithium iron phosphate (LiFePO₄). For instance, typical LiCoO₂ has a specific capacity of about 140 mAh/g to about 150 mAh/g and energy density of about 400 Wh/kg to about 500 Wh/kg.

In certain aspects, the doped polyol reduced graphene cathode material exhibits an energy density ranging from greater than about 500 Wh/kg, greater than about 550 Wh/kg, greater than about 600 Wh/kg, greater than about 650 Wh/kg, greater than about 700 Wh/kg, greater than about 750 Wh/kg, greater than about 800 Wh/kg, greater than about 850 Wh/kg, greater than about 900 Wh/kg, greater than about 950 Wh/kg, greater than about 1000 Wh/kg, greater than about 1000 Wh/kg, greater than about 1100 Wh/kg, greater than about 1150 Wh/kg, greater than about 1200 Wh/kg, or greater than about 1250 Wh/kg. In another aspect the doped polyol reduced graphene cathode material exhibits an energy density ranging from greater than about 500 Wh/kg to about 2500 Wh/kg For example, the energy density may be from about 505 Wh/kg to about 2450 Wh/kg, about 550 Wh/kg to about 2400 Wh/kg, about 600 Wh/kg to about 2350 Wh/kg, about 650 Wh/kg to about 2300 Wh/kg, about 700 Wh/kg to about 2250 Wh/kg, about 750 Wh/kg to about 2200 Wh/kg, about 800 Wh/kg to about 2150 Wh/kg, about 850 Wh/kg to about 2100 Wh/kg, about 900 Wh/kg to about 2050 Wh/kg, about 950 Wh/kg to about 2000 Wh/kg, about 1000 Wh/kg to about 1950 Wh/kg, about 1100 Wh/kg to about 1900 Wh/kg, about 1150 Wh/kg to about 1850 Wh/kg, about 1200 Wh/kg to about 1800 Wh/kg, about 1250 Wh/kg to about 1750 Wh/kg, about 1300 Wh/kg to about 1700 Wh/kg, about 1350 Wh/kg to about 1850 Wh/kg, about 1400 Wh/kg to about 1800 Wh/kg, about 1450 Wh/kg to about 1750 Wh/kg, about 1500 Wh/kg to about 1700 Wh/kg, or about 1550 Wh/kg about 1650 Wh/kg. In some embodiments, the energy density may be from about 510 Wh/kg to about 700 Wh/kg, 520 Wh/kg to about 800 Wh/kg, 530 Wh/kg to about 900 Wh/kg, or 540 Wh/kg to about 1000 Wh/kg. In some embodiments, the energy density may be from about 600 Wh/kg to about 800 Wh/kg. In some embodiments, the energy densities may be from about 500.0 Wh/kg to about 550.0 Wh/kg, from about 500.0 Wh/kg to about 540.0 Wh/kg, or from about 504.4 Wh/kg to about 537.9 Wh/kg. The higher energy density relative to lithium-based cathode material indicates the compactness of the system.

In certain aspects, the doped polyol reduced graphene cathode material may have a specific capacity of ranging from about 200 mAh/g to about 750 mAh/g. For example, the specific capacity may be from about 210 mAh/g to about 740 mAh/g, about 220 mAh/g to about 730 mAh/g, about 230 mAh/g to about 720 mAh/g, about 240 mAh/g to about 710 mAh/g, about 250 mAh/g to about 700 mAh/g, about 260 mAh/g to about 690 mAh/g, about 270 mAh/g to about 680 mAh/g, about 280 mAh/g to about 670 mAh/g, about 290 mAh/g to about 660 mAh/g, about 300 mAh/g to about 650 mAh/g, about 310 mAh/g to about 640 mAh/g, about 320 mAh/g to about 630 mAh/g, about 330 mAh/g to about 620 mAh/g, about 340 mAh/g to about 610 mAh/g, about 350 mAh/g to about 600 mAh/g, about 360 mAh/g to about 590 mAh/g, about 370 mAh/g to about 580 mAh/g, about 380 mAh/g to about 570 mAh/g, about 390 mAh/g to about 560 mAh/g, about 400 mAh/g to about 550 mAh/g, about 410 mAh/g to about 540 mAh/g, about 420 mAh/g to about 530 mAh/g, about 430 mAh/g to about 520 mAh/g, about 440 mAh/g to about 510 mAh/g, about 450 mAh/g to about 500 mAh/g, about 460 mAh/g to about 490 mAh/g, or about 470 mAh/g to about 480 mAh/g. In some embodiments, the specific capacity may be from about 200 mAh/g to about 300 mAh/g. In other embodiments, the specific capacity may be from about 300 mAh/g to about 400 mAh/g. In yet other embodiments, the specific capacity may be about 300 mAh/g or greater.

In certain aspects, the doped polyol reduced graphene cathode material has a capacity retention of greater than 70% over a number of charge/discharge cycles. The number of cycles may be about 300, about 350, about 400, about 450, about 500, about 550, about 600, about 650, or about 700. The greater than 70% capacity retention reflects the materials the long-term durability. For example, the capacity retention may range from about 70% to about 95%, about 75% to about 90%, or about 80% or about 85% over 500 charge/discharge cycles. In one or more embodiments, the capacity retention over 500 cycles may be greater than about 70%, about 75%, about 80%, about 85%, about 90% or about 95%.

In certain aspects, the doped polyol reduced graphene cathode material may have an electronic conductivity ranging from on the order of about 9.0×10³ S/cm to about 0.5×10⁴ S/cm, about 7.5×10³ S/cm to about 0.5×10⁴ S/cm, about 5.0×10³ S/cm to about 0.5×10⁴ S/cm, about 3.0×10³ S/cm to about 1.0×10⁴ S/cm, or about 1.0×10³ S/cm to about 1.0×10⁴ S/cm. In some embodiments, the electronic conductivity ranges from about 9.0×10³ S/cm to about 1.0×10⁴ S/cm. In some embodiments, the electronic conductivity ranges from about 7.5×10³ S/cm to about 9.0×10³ S/cm. In some embodiments, the electronic conductivity ranges from about 5.0×10³ S/cm to about 7.5×10³ S/cm. In some embodiments, the electronic conductivity ranges from about 3.0×10³ S/cm to about 5×10³ S/cm. In some embodiments, the electronic conductivity ranges from about 1.0×10³ S/cm to about 3.0×10³ S/cm. In some embodiments, the electronic conductivity ranges from about 7.5×10³ S/cm to about 1.0×10⁴ S/cm. In some embodiments, the electronic conductivity ranges from about 3.0×10³ S/cm to about 7.5×10³ S/cm. In some embodiments, the electronic conductivity ranges from about 1.0×10³ S/cm to about 5×10³ S/cm. This electronic conductivity may enable efficient electron transfer during battery operations.

### Cathode Material—Co-Doped Triethylene Glycol Reduced Graphene

TEG is of particular interest because TEG has superior reducing capability and provides better control over the reduction process of graphene oxide relative to other polyols. In some embodiments of the present disclosure the polyol of the cathode material is TEG.

In some embodiments of the cathode material a TEG reduced graphene (TRG) is co-doped with nitrogen (N) and sulfur (S). The nitrogen and sulfur atoms may be incorporated in the form of pyridinic, pyrrolic, graphitic, and thiophenic configurations, which contribute to enhanced electrochemical performance. Co-doping of nitrogen and sulfur may result in synergistic effects resulting to the enhanced performance from both elements' combined doping. Nitrogen doping typically improves electronic conductivity, while sulfur doping enhances capacity by facilitating additional charge storage mechanisms. When co-doped, these effects may complement each other, leading to significantly improved electrochemical performance compared to single doping. The most desirable configuration may depend on the specific application. Pyridinic and pyrrolic nitrogen tend to contribute to higher capacity due to their additional lithium storage sites. Graphitic nitrogen may improve conductivity. Thiophenic S may boost capacity too.

The co-doped TRG of the present disclosure may have a multi-component chemical structure, including graphene oxide, nitrogen, and sulfur. The chemical structure, molecular weight, and particle size may be controlled by varying the ratio of dopants, synthesis procedure, or a combination thereof.

The chemical formula of the cathode material of the present disclosure is CₓH_{y}O_{z}NₘSₙ, where x, y, z, m, and n are integers or decimal numbers. In the formula, x ranges from about 1 to about 10, y is about 1 to about 20, z is about 0 to about 5, m is greater than 0 to about 15, and n is greater than 0 to about 15. X, y, z, m, n may be integers or decimal numbers.

In some embodiments, x ranges from about 1 to about 10, about 1.5 to about 9.5, about 2 to about 9, about 2.5 to about 8.5, about 3 to about 8.0, about 3.5 to about 7.5, about 4 to about 7.0, about 4.5 to about 6.5, or about 5.0 to about 6.0. For example, x may be 1, 1.25, 1.5, 1.75, 2.0, 2.25, 2.5, 2.75, 3.0, 3.25, 3.5, 3.75, 4.0, 4.25, 4.5, 4.75, 5.0, 5.25, 5.5, 5.75, 6.0, 6.25, 6.5, 6.75, 7.0, 7.25, 7.5, 7.75, 8.0, 8.25, 8.75, 9.0, 9.25, 9.5, 9.75, or 10.

In some embodiments, y ranges from about 1 to about 20, about 1.5 to about 19.5, about 2 to about 19, about 2.5 to about 18.5, about 3 to about 18, from about 3.5 to about 17.5, about 4 to about 17, about 4.5 to about 16.5 about 5.0 to about 16, about 5.5 to about 16, about 6.0 to about 15.5, about 6.5 to about 15, about 7.0 to about 14.5, about 7.5 to about 14, about 8 to about 13.5. about 8.5 to about 13, about 9 to about 12.5, about 9.5 to about 12, about 10 to about 11.5, or about 10 to about 10.5. For example, y may be 1, 1.25, 1.5, 1.75, 2.0, 2.25, 2.5, 2.75, 3.0, 3.25, 3.5, 3.75, 4.0, 4.25, 4.5, 4.75, 5.0, 5.25, 5.5, 5.75, 6.0, 6.25, 6.5, 6.75, 7.0, 7.25, 7.5, 7.75, 8.0, 8.25, 8.5, 8.75, 9.0, 9.25, 9.5, 10, 10.25, 10.5, 10.75, 11, 11.25, 11.5, 11.75, 12.0, 12.25, 12.5, 12.75, 13.0, 13.25, 13.5, 13.75, 14.0, 14.25, 14.5, 14.75, 15.0, 15.25, 15.5, 15.75, 16.0, 16.25, 16.5, 16.75, 17.0, 17.25, 17.5, 17.75, 18.0, 18.25, 18.5, 18.75, 19.0, 19.25, 19.5, 19.75, or 20.

In some embodiments, z ranges from about 0 to about 5, about 0.5 to about 4.5, about 1 to about 4, about 1.5 to about 3.5, about 2 to about 3.0, or about 2.5 to about 2.75. For example, z may be 0.1, 0.2, 0.3, 0.4, 0.5, 0.6, 0.7, 0.8, 0.9, 1.0, 1.1, 1.2, 1.25, 1.3, 1.4, 1.5, 1.6, 1.7, 1.75, 1.8, 1.9, 2.0, 2.1, 2.2, 2.25, 2.3, 2.4, 2.5, 2.6, 2.7, 2.75, 2.8, 2.9, 3.0, 3.1, 3.2, 3.25, 3.3, 3.4, 3.5, 3.6, 3.7, 3.75, 3.8, 3.9, 4.0, 4.1, 4.2, 4.25, 4.3, 4.4, 4.5, 4.6, 4.7, 4.75, 4.8, 4.9, or 5.0.

In some embodiments, m ranges from about 0.1 to about 15.0, about 0.5 to about 14.5, about 1.0 to about 14.0, about 1.5 to about 13.5, about 2.0 to about 13.0, about 2.5 to about 12.5, about 3.0 to about 12.0, about 3.5 to about 11.5, about 4.0 to about 11.0, about 4.5 to about 10.5, about 5.0 to about 10.0, about 5.5 to about 9.5, about 6.0 to about 9.0, about 6.5 to about 8.5, or about 7.0 to about 8.0. For example, m may be 0.1, 0.2, 0.3, 0.4, 0.5, 0.6, 0.7, 0.8, 0.9, 1.0, 1.1, 1.2, 1.25, 1.3, 1.4, 1.5, 1.6, 1.7, 1.75, 1.8, 1.9, 2.0, 2.1, 2.2, 2.25, 2.3, 2.4, 2.5, 2.6, 2.7, 2.75, 2.8, 2.9, 3.0, 3.1, 3.2, 3.25, 3.3, 3.4, 3.5, 3.6, 3.7, 3.75, 3.8, 3.9, 4.0, 4.1, 4.2, 4.25, 4.3, 4.4, 4.5, 4.6, 4.7, 4.75, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.75, 12.8, 12.9, 13.0, 13.1, 13.2, 13.25, 13.3, 13.4, 13.5, 13.6, 13.7, 13.75, 13.8, 13.9, 14.0, 14.1, 14.2, 14.25, 14.3, 14.4, 14.5, 14.6, 14.7, 14.75, 14.8, 14.9, or 15.0.

In some embodiments, n ranges from about 0.1 to about 15.0, about 0.5 to about 14.5, about 1.0 to about 14.0, about 1.5 to about 13.5, about 2.0 to about 13.0, about 2.5 to about 12.5, about 3.0 to about 12.0, about 3.5 to about 11.5, about 4.0 to about 11.0, about 4.5 to about 10.5, about 5.0 to about 10.0, about 5.5 to about 9.5, about 6.0 to about 9.0, about 6.5 to about 8.5, or about 7.0 to about 8.0. For example, n may be 0.1, 0.2, 0.3, 0.4, 0.5, 0.6, 0.7, 0.8, 0.9, 1.0, 1.1, 1.2, 1.25, 1.3, 1.4, 1.5, 1.6, 1.7, 1.75, 1.8, 1.9, 2.0, 2.1, 2.2, 2.25, 2.3, 2.4, 2.5, 2.6, 2.7, 2.75, 2.8, 2.9, 3.0, 3.1, 3.2, 3.25, 3.3, 3.4, 3.5, 3.6, 3.7, 3.75, 3.8, 3.9, 4.0, 4.1, 4.2, 4.25, 4.3, 4.4, 4.5, 4.6, 4.7, 4.75, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.75, 12.8, 12.9, 13.0, 13.1, 13.2, 13.25, 13.3, 13.4, 13.5, 13.6, 13.7, 13.75, 13.8, 13.9, 14.0, 14.1, 14.2, 14.25, 14.3, 14.4, 14.5, 14.6, 14.7, 14.75, 14.8, 14.9, or 15.0.

In some aspects of the present disclosure, the cathode material may be a nitrogen and sulfur co-doped TEG reduced graphene. The nitrogen to sulfur (N/S) ratio in the co-doped TEG reduced graphene may be varied to optimize the electrochemical properties of the resulting cathode electrode. The nitrogen to sulfur ratio may range from about 1:1 to about 5:1. For example, the ratio may be 1:1, 1.1:1, 1.2:1, 1.3:1, 1.4:1, 1.5:1, 1.6:1, 1.7:1, 1.8:1, 1.9:1, 2:1, 2.1:1, 2.2:1, 2.3:1, 2.4:1, 2.5:1, 2.6:1, 2.7:1, 2.8:1, 2.9:1, 3:1, 3.1:1, 3.2:1, 3.3:1, 3.4:1, 3.5:1, 3.6:1, 3.7:1, 3.8:1, 3.9:1, 4:1, 4.1:1, 4.2:1, 4.3:1, 4.4:1, 4.5:1, 4.6:1, 4.7:1, 4.8:1, 4.9:1, or 5:1. Ideal ratios may depend on optimization between capacity, stability, and conductivity, and may vary significantly based on experimental conditions and specific battery requirements. The desired ratio may depend on the desired properties of the cathode material, such as its capacity, conductivity, and cycle life.

Aspects of the present disclosure includes characterization of the doped polyol reduced graphene by analytical techniques including but not limited to x-ray crystallography (XRD), X-ray photoelectron spectroscopy (XPS), thermal gravimetric analysis (TGA), ¹³C NMR, or Raman spectroscopy.

X-ray Photoelectron Spectroscopy (XPS) is a surface-sensitive quantitative spectroscopic technique that measures the elemental composition, empirical formula, chemical state, and electronic state of the elements within a material. In certain aspects, XPS may be used to measure the elemental composition, chemical state, and electronic state of the co-doped TRG material. The XPS measurements of co-doped TRG material may provide information about its elemental composition, chemical state, and electronic state. XPS analysis may reveal the presence of carbon (C), nitrogen (N), oxygen (O), and sulfur (S) elements in the co-doped triethylene glycol reduced graphene. The binding energies of these elements may be used to determine their chemical bonding and oxidation states. Additionally, XPS spectra may exhibit characteristic peaks corresponding to functional groups or surface contaminants, which may provide insights into the surface chemistry of co-doped TRG.

The elemental scan for the co-doped TRG cathode may confirm the successful co-doping of nitrogen and sulfur into the graphene structure. The relative intensities of the O1s, N1s, C1s, and S2p peaks may provide an estimate of the atomic ratios of these elements in the co-doped TRG. This information may be used to assess the doping level and the influence of these dopants on the electrochemical properties of the electrode. The high-resolution scans of these peaks can reveal the binding energy of the electrons, which is characteristic of the specific element and its chemical state.

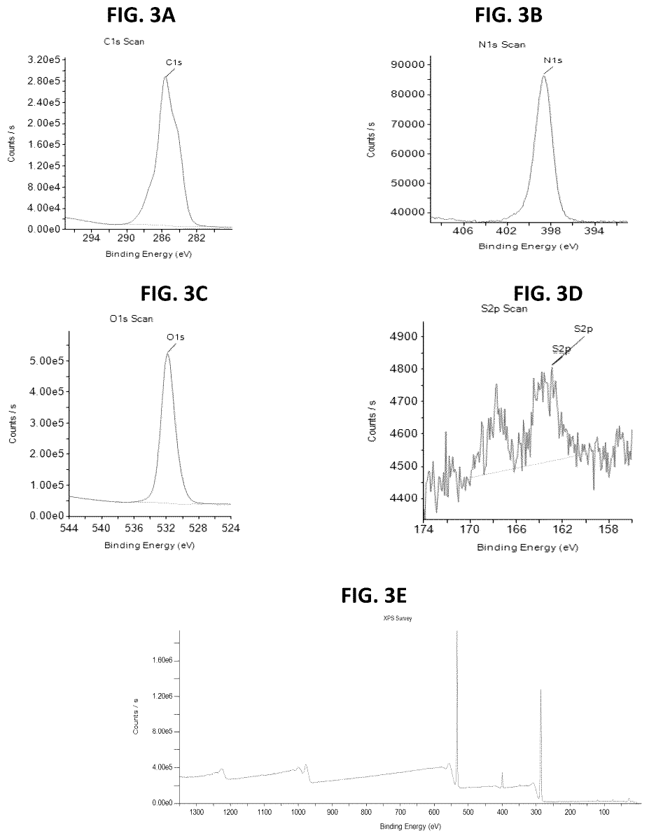

FIGS. 3A-3D are an C1s, N1s, O1s, and S2p XPS spectrum obtained by elemental scans from a TRG cathode material in some embodiments of the present disclosure. The high-resolution elemental scans reveal the extensive functionalization of the surface of the TRG cathode material. This characteristic is not a superficial attribute but may play a pivotal role in the cathode's electrochemical performance.

The functionalization process may involve the addition of functional groups to the graphene surface, altering its chemical reactivity and, consequently, its electrochemical behavior. This modification may not be random or uneven. It may be uniform across the entire graphene surface. This uniformity may be a critical factor that may directly influence the cathode's ability to deliver a large intercalation capacity.

In an electrochemical cell, the cathode's surface is the primary site for electrochemical reactions. Therefore, the more extensively and uniformly functionalized the surface is, the more sites are available for these reactions to occur. This increase in reaction sites may enhance the cathode's ability to intercalate incoming ions, which may directly translate to a larger capacity for ion storage.

In essence, the extensive and uniform functionalization of the TRG cathode surface, as revealed by the high-resolution N1s, O1s and S2p XPS spectra, is a key feature that may enable the cathode to deliver a large intercalation capacity. This capacity is a crucial parameter that may determine the energy storage capability of the cell. Thus, the functionalization process may have profound implications for the performance of the TRG as a cathode material in energy storage applications.

The C1s scan may provide insights into the types of carbon bonds present. FIG. 3A reveals the presence of various carbon bonds, including C—C or C═C (typical in graphene), C—O and C═O (indicative of functional groups). The relative intensities of these peaks may indicate the degree of functionalization, with higher intensities of C—O, C═O, or O—C═O peaks suggesting extensive functionalization.

Referring to FIG. 3B, the N1s scan reveal the presence of various nitrogen bonds, including Pyridinic N (—C—N—C—), Pyrrolic N (—C—N—C—H), Graphitic N (—C—N—C—C—), and Oxidized N (—N—O or —N═O). The relative intensities of these peaks in the N1s scan may indicate the types and amounts of nitrogen doping or functionalization.

Referring to FIG. 3C, the O1s scan reveal various oxygen bonds, including C—O (representing ether or hydroxyl groups), C═O (representing carbonyl groups), and O—C═O (representing carboxyl groups). The relative intensities of these peaks in the O1s scan may indicate the degree of functionalization of the graphene.

Referring to FIG. 3D, the S2p scan reveal various sulfur bonds, including C—S (representing sulfur-containing groups attached to the carbon lattice), C═S (representing double-bonded sulfur groups), and S—O (representing sulfur-oxygen groups).

The survey scan may provide a broad overview of all elements present on the surface of the co-doped TRG cathode. In some embodiments, the survey scan confirms the presence of the expected elements (C, N, S, O) and can also reveal the presence of any unexpected or trace elements. The absence of peaks corresponding to impurities or unreacted precursors indicates the high purity of the co-doped triethylene glycol reduced graphene cathode, which is essential for achieving optimal performance in energy storage applications. Any unexpected peaks could indicate contamination or incomplete reactions during the fabrication process, which would need to be addressed in future fabrication runs. FIG. 3E shows a survey scan of some embodiments of co-doped TRG materials.

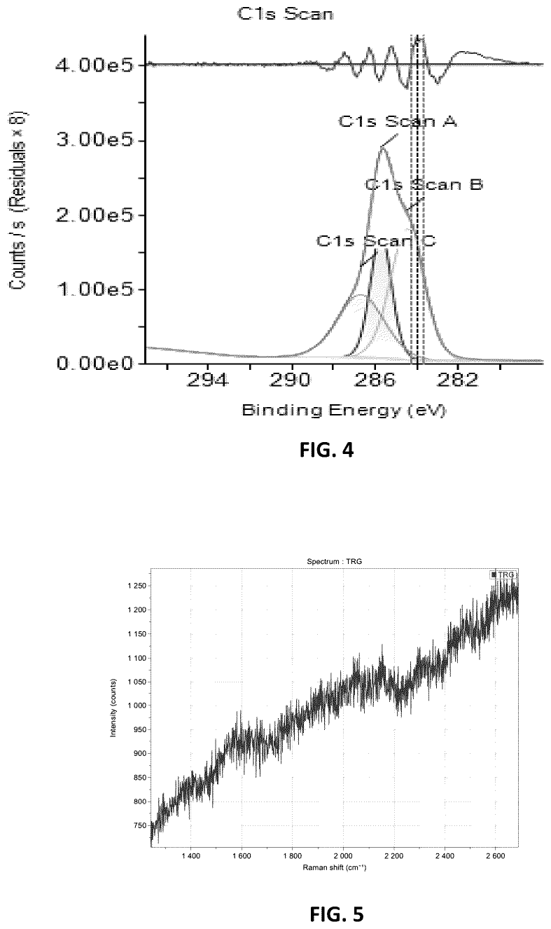

The peak fitting scan may provide detailed information about the chemical states of the elements present. For example, the N1s peak may be deconvoluted into several components corresponding to different nitrogen functionalities (e.g., pyridinic N, pyrrolic N, graphitic N, etc.). The relative intensities of these components provide insights into the types of nitrogen doping in the co-doped TRG. This information may be useful as different nitrogen functionalities may have different effects on the electrochemical properties of the electrode. Similarly, the S2p peak may provide information about the types of sulfur functionalities present. The presence of different sulfur functionalities may influence the electronic structure of the graphene and hence its interaction with the electrolyte during energy storage. For example, graphitic nitrogen is known to enhance the electronic conductivity of the graphene, while sulfur functionalities may influence the interaction of the graphene with the electrolyte. FIG. 4 is a representative peak fitting scan of the C1s peak in some embodiments of co-doped TRG materials.

In one embodiment, the XRD pattern (2-theta values) of the co-doped triethylene glycol reduced graphene exhibits a peak at 23°±0.75, 23°±0.50, 23°±0.25, and/or 23°±0.10, whereas the graphene oxide has a peak at 26.5° 0.75, 26.5°±0.50, 26.5°±0.25, and/or 26.5°±0.10. The peaks at different angles (2-theta values) represent the different interlayer spacings or d-spacings in graphene oxide and co-doped triethylene glycol reduced graphene. For graphene oxide, a typical peak may be observed at approximately 26.5°, which corresponds to the (001) plane, indicating a larger interlayer spacing due to the presence of oxygen functional groups. The peak for co-doped TRG shifts to a lower angle, approximately 23° in this case, indicating a reduction in the interlayer spacing due to the removal of oxygen groups during the reduction process and possible intercalation by dopants. The peak shift indicates the reduction of graphene oxide to graphene.

In another embodiment, TGA of the co-doped triethylene glycol reduced graphene shows a major weight loss at a higher temperature relative to graphene oxide, indicating enhanced thermal stability. In another embodiment, ¹³C NMR exhibits major weight loss at a higher temperature than graphene oxide, indicating thermal stability.

Raman spectroscopy is a powerful technique for the characterization of carbon materials like graphene, as it provides information about the vibrational modes of the atoms in the material. The intensity, position, and width of the Raman peaks may provide insights into the number of graphene layers, the presence of defects, and the level of doping. The instrument parameters may influence the sensitivity, resolution, and spectral range of the Raman spectra obtained from the co-doped TRG cathode. For instance, the detector type may influence the sensitivity and resolution of the Raman spectra. The stage size and type may affect the area of the sample that may be analyzed and the precision of the sample positioning. The choice of laser wavelength may affect the Raman scattering efficiency and the types of Raman modes that may be excited. The acquisition options parameters may influence the quality of the Raman spectra, affecting aspects such as resolution, signal-to-noise ratio, and the accuracy of the data. For example, binning is a process that combines the charge collected by multiple pixels to form a ‘super’ pixel. A binning of 1 means that each pixel is read individually, which may provide higher resolution but potentially lower signal-to-noise ratio. The acquisition parameters may influence the quality and type of Raman spectra obtained from the co-doped triethylene glycol reduced cathode, affecting aspects such as spectral range, signal-to-noise ratio, and the overall acquisition time. For example, the choice of spectral range may affect the types of Raman modes that may be detected.

The Raman spectroscopy analysis may provide information about the co-doped TRG cathode. The detailed spectral and spatial data may be crucial for understanding the performance of the co-doped TRG cathode in electrochemical applications. The choice of instrument setup, acquisition options, and acquisition parameters may play a significant role in the quality and type of data obtained.

Some embodiments of the present disclosure include a composition comprising the Raman spectra of FIG. 5.

In some embodiment, the Raman spectra shows an increase in the D/G band intensity ratio in doped polyol reduced graphene indicating increased disorder due to doping.

In some embodiments, the energy density of the co-doped TEG reduced graphene may be from about 510 Wh/kg to about 700 Wh/kg. In some embodiments, the energy density may be from about 600 Wh/kg to about 800 Wh/kg. The higher energy density relative to lithium-based cathode material indicates the compactness of the system.

In one or more embodiments, the specific capacity of the co-doped TEG reduced graphene may be from about 200 mAh/g to about 300 mAh/g. In other embodiments, the specific capacity may be from about 300 mAh/g to about 400 mAh/g.

In one or more embodiments, the capacity retention of the co-doped TEG reduced graphene over 500 cycles may be greater than about 70%, about 75%, about 80%, about 85%, about 90% or about 95%, or about 95% or higher. In one or more embodiments, the capacity retention of the co-doped TEG reduced graphene over 500 cycles may be from about 70% to about 75%, from about 75% to about 80%, from about 80% to about 85%, from about 85% to about 90%, from about 90% to about 95%, or about 95% or greater. This range may be influenced by factors such as the synthesis method, charge/discharge rate, depth of discharge, operating temperature, and/or electrolyte type/concentration. High values for capacity retention is not easily achieved due to the inherent degradation mechanisms in batteries, including the formation and growth of solid electrolyte interface (SEI) layer, and active material degradation.

In one or more embodiments, the electronic conductivity of the co-doped TEG reduced graphene cathode material may have an electronic conductivity ranging from on the order of about 10³ S/cm to about 10⁴ S/cm.

Cathodes and Batteries Made from the Cathode Material

The present disclosure also includes cathodes made from the cathode materials described above. The present disclosure also includes batteries made from the cathodes from the cathode materials.

A cathode is constituted by a cathode material, a conductive material, a current collector, and a binder (binding agent). A cathode is typically made by mixing a cathode material, a binder, a solvent, and optionally additives. The binder helps in adhering the cathode material to the current collector and maintaining structural integrity during battery cycling. The solvent helps to form a solution with all the components dissolved or suspended in it.

In some embodiments of the present disclosure, the cathode material may be any material described above. For example, the cathode material may be a doped polyol reduced graphene, a doped TEG reduced graphene, or co-doped TEG reduced graphene. In some embodiments, or nitrogen and sulfur co-doped TEG reduced graphene.

Examples of suitable binders include but are not limited to biopolymers, polyvinylidene fluoride (PVDF), styrene-butadiene rubber (SBR), or combinations thereof. The biopolymers include but are not limited to chitosan, alginate, cellulose derivatives, and combinations thereof. Notably, chitosan is superior to alginate and cellulose derivatives as an eco-friendly binder due to its biocompatibility, strong film-forming properties, and excellent adhesion and/or cohesion. These characteristics make chitosan a preferred choice for fabricating electrodes in energy storage devices, ensuring mechanical integrity and performance.

In some embodiments, the binder may be chitosan. Chitosan is biocompatible, biodegradable, and has film-forming properties. Different grades and formulations of chitosan may vary in properties and performance. Chitosan acts as an eco-friendly alternative to the conventional petroleum-based binders such as PVDF or SBF. The chitosan may be derived from a naturally occurring polymer including a naturally occurring polymer found in the shells of crustaceans. PVDF or SBR binders provide enhanced mechanical strength, adhesion, stability, or combination thereof. Thus, a combination of binders may be desired depending on specific requirements, performance goals, and optimization needs of the cathode and subsequent energy storage device. In some embodiments, the chitosan may be derived from chitin.

In some embodiments, the solvent may be an acid. The acid may be an organic or an inorganic acid. Example of suitable acids include but are not limited to any one of acetic acid, hydrochloric acid, formic acid, lactic acid, citric acid, or combinations thereof. The choice of solvent may be linked to the dissolving and dispersion of chitosan, which is used as a binder and a doping agent. Chitosan is a polymer that is soluble in many dilute acids due to the presence of amine groups. Furthermore, the choice of solvent may impact the properties of the final material, including the degree of deprotonation and the level of cross-linking in the chitosan. In one embodiment, the acid may be acetic acid. In other embodiments, the solvent may be a weak acid or an organic acid.

The cathode formed using doped polyol reduced graphene or co-doped triethylene glycol reduced graphene and the chitosan binder may be utilized in various battery configurations including but not limited to coin cells, pouch cells, or prismatic cell. The specific design considerations and assembly methods may vary depending on the battery format. In some embodiments, the cathode may be used in coin cells. For example, the cathode may be used in a coin cell with a 2032 form factor. In other embodiments, the cathode may be used in prismatic cells and/or prismatic batteries.

The thickness of the cathode depends on the intended application, the performance requirements of the cathode, and the manufacturing feasibility. The thickness of the cathode may be optimized based on the desired energy density, power output, and other factors to achieve the desired performance.

The thickness of the cathode ranges from about 50 μm to about 500 μm. For example, the thickness may be from about 75 μm to about 475 μm, about 100 μm to about 450 μm, about 125 μm to about 425 μm, about 150 μm to about 400 μm, about 175 μm to about 375 μm, about 200 μm to about 350 μm, about 225 μm to about 325 μm, about 250 μm to about 300 μm, or about 275 μm to about 290 μm. In some embodiments, the thickness may be 100 μm, 150 μm, 200 μm, 250 μm, 300 μm, 350 μm, 400 μm, or 450 μm. In some embodiments, the thickness of the cathode is around 150 μm to around 250 μm. A cathode thickness of 600 μm or greater may pose challenges related to ion diffusion and mechanical stability, especially for high energy density materials like the co-doped triethylene glycol reduced graphene (TRG). However, considering the improved properties of the co-doped TRG disclosed herein, such as increased specific capacity and superior electronic conductivity, it may be possible to use thicker cathodes (e.g., 500 μm or greater, 600 μm or greater, or 700 μm or greater) without sacrificing performance.

The density of the cathode may be used to optimize the packing density of the active cathode material, binder, and other additives, while simultaneously maintaining the electrochemical performance and mechanical stability.

The density of the cathode ranges from about 1.4 g/cm³ to about 2.4 g/cm³. For examples, the density may be from about 1.5 g/cm³ to about 2.3 g/cm³, 1.6 g/cm³ to about 2.2 g/cm³, 1.7 g/cm³ to about 2.1 g/cm³, or 1.8 g/cm³ to about 2.0 g/cm³. In one embodiment, the density is from 1.4 g/cm³ to 1.8 g/cm³.

In certain aspects, cathodes made from the cathode materials exhibit an energy density ranging from greater than 500 Wh/kg to about 2500 Wh/kg. For example, the energy density may be from about 505 Wh/kg to about 2450 Wh/kg, about 550 Wh/kg to about 2400 Wh/kg, about 600 Wh/kg to about 2350 Wh/kg, about 650 Wh/kg to about 2300 Wh/kg, about 700 Wh/kg to about 2250 Wh/kg, about 750 Wh/kg to about 2200 Wh/kg, about 800 Wh/kg to about 2150 Wh/kg, about 850 Wh/kg to about 2100 Wh/kg, about 900 Wh/kg to about 2050 Wh/kg, about 950 Wh/kg to about 2000 Wh/kg, about 1000 Wh/kg to about 1950 Wh/kg, about 1100 Wh/kg to about 1900 Wh/kg, about 1150 Wh/kg to about 1850 Wh/kg, about 1200 Wh/kg to about 1800 Wh/kg, about 1250 Wh/kg to about 1750 Wh/kg, about 1300 Wh/kg to about 1700 Wh/kg, about 1350 Wh/kg to about 1850 Wh/kg, about 1400 Wh/kg to about 1800 Wh/kg, about 1450 Wh/kg to about 1750 Wh/kg, about 1500 Wh/kg to about 1700 Wh/kg, or about 1550 Wh/kg about 1650 Wh/kg. In some embodiments, the energy density may be from about 510 Wh/kg to about 700 Wh/kg. In some embodiments, the energy density may be from about 600 Wh/kg to about 800 Wh/kg. The higher energy density relative to lithium-based cathode material indicates the compactness of the system.

In certain aspects, cathodes made from the cathode materials of the present disclosure may have a specific capacity of ranging from about 200 mAh/g to about 750 mAh/g. For example, the specific capacity may be from about 210 mAh/g to about 740 mAh/g, about 220 mAh/g to about 730 mAh/g, about 230 mAh/g to about 720 mAh/g, about 240 mAh/g to about 710 mAh/g, about 250 mAh/g to about 700 mAh/g, about 260 mAh/g to about 690 mAh/g, about 270 mAh/g to about 680 mAh/g, about 280 mAh/g to about 670 mAh/g, about 290 mAh/g to about 660 mAh/g, about 300 mAh/g to about 650 mAh/g, about 310 mAh/g to about 640 mAh/g, about 320 mAh/g to about 630 mAh/g, about 330 mAh/g to about 620 mAh/g, about 340 mAh/g to about 610 mAh/g, about 350 mAh/g to about 600 mAh/g, about 360 mAh/g to about 590 mAh/g, about 370 mAh/g to about 580 mAh/g, about 380 mAh/g to about 570 mAh/g, about 390 mAh/g to about 560 mAh/g, about 400 mAh/g to about 550 mAh/g, about 410 mAh/g to about 540 mAh/g, about 420 mAh/g to about 530 mAh/g, about 430 mAh/g to about 520 mAh/g, about 440 mAh/g to about 510 mAh/g, about 450 mAh/g to about 500 mAh/g, about 460 mAh/g to about 490 mAh/g, or about 470 mAh/g to about 480 mAh/g. In some embodiments, the specific capacity may be from about 200 mAh/g to about 300 mAh/g. In other embodiments, the specific capacity may be from about 300 mAh/g to about 400 mAh/g.

In certain aspects, the cathode made from the co-doped triethylene glycol reduced graphene cathode material has a capacity retention of greater than 70% over a number of charge/discharge cycles. The number of cycles may be about 450, about 500, about 550, about 600, about 650, or about 700. The greater than 80% capacity retention reflects the materials long-term durability. For example, the capacity retention may range from about 70% to about 95%, about 75% to about 90%, or about 80% or about 85% over 500 charge/discharge cycles. In one or more embodiments, the capacity retention over 500 cycles may be greater than about 70%, about 75%, about 80%, about 85%, about 90% or about 95%.

In some aspects of the present disclosure, the cathode made from doped polyol reduced graphene cathode material may be assembled into a coin cell battery. As previously stated, the cathode material may be co-doped with nitrogen and sulfur. The cathode material may be reduced with TEG. The cathode material may be nitrogen and sulfur co-doped TEG reduced graphene.

In some aspects, nitrogen and sulfur co-doped TEG reduced graphene cathodes may be incorporated into coin cells as the cathode material layered onto a current collector and separated from the anode by an electrolyte-filled separator. The nitrogen and sulfur co-doped TEG reduced graphene cathodes may also be used in other battery configurations, such as pouch or prismatic cells, or different chemistries like sodium-ion, potassium-ion, or dual-ion batteries.

The nitrogen and sulfur co-doping may enhance the electronic conductivity and redox activity, contributing to the increased specific capacity, energy density, and cycling stability of the batteries. The nitrogen and sulfur co-doped TEG reduced graphene cathode material may lead to the development of more efficient, compact, and lightweight energy storage solutions, benefiting portable electronics, wearable technology, and small-scale energy storage industries.

In some aspects, the coin cell battery may operate in a voltage range from about 2.0 V to about 5.0 V, about 2.5 V to about 5.0 V, about 2.0 V to about 4.2 V, or about 2.5 V to about 4.2 V. For example, the voltage range may be about 2.1 V to about 4.9 V, about 2.2 V to about 4.8 V, about 2.3 V to about 4.7 V, about 2.4 V to about 4.6 V, about 2.5 V to about 4.5 V, about 2.6 V to about 4.4 V, about 2.7 V to about 4.3 V, about 2.8 V to about 4.2 V, 2.9 V to about 4.1 V, about 3.0 V to about 3.9 V, about 3.1 V to about 3.8 V, about 3.2 V to about 3.7 V, or about 3.3 V to about 3.6 V, or about 3.4 V to about 3.5 V. In some embodiments, the voltage may be from 2.5 V to 4.2 V.

Notably, the voltage of the disclosed coin cell battery may be higher than 3.6 V lithium-ion coin cell batteries. In some embodiments, the voltage may be ≥4.3 V, ≥4.2 V, ≥4.1 V, ≥4.0 V, ≥3.9 V, ≥3.8 V, or ≥3.7 V.

In some aspects, the disclosed coin cell battery may have a 60-170% increase in energy density compared to 3.6 V lithium-ion coin cell batteries. For example, the increase in energy density range from about 60% to about 170%, about 65% to about 165%, about 70% to about 160%, about 75% to about 155%, about 80% to about 150%, about 85% to about 145%, about 90% to about 140%, about 95% to about 135%, about 100% to about 130%, about 105% to about 125%, about 110% to about 120%, or about 112% to about 115%.

In some aspects, the disclosed coin cell battery may have a capacity ranging from about 30 mAh to about 60 mAh. For example, the capacity may range from about 35 mAh to about 55 mAh, about 40 mAh to about 50 mAh, or about 45 mAh to about 47 mAh.

### Methods of Making Doped Polyol Reduced Graphene

The present disclosure also includes methods of making cathode materials. The method includes forming a doped polyol reduced graphene material from graphene oxide, a polyol, and a plurality of dopants.

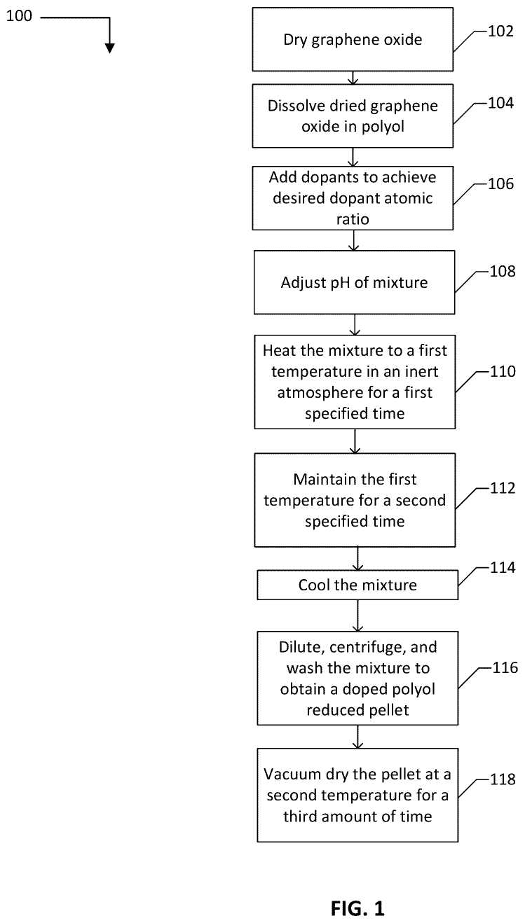

In some aspects, the cathode material is doped polyol reduced graphene. FIG. 1 shows a method of making doped polyol reduced graphene. The method 100 of making doped polyol reduced graphene includes drying graphene oxide 102; dissolving the dried graphene oxide in a polyol to form a graphene oxide solution in polyol 104; adding dopants to the graphene oxide solution to form a mixture 106; adjusting the pH of the mixture to between 9 and 10 108; heating the mixture to a first temperature in an inert atmosphere for a first specified time 110; maintaining the first temperature for a second specified amount of time to form a doped polyol reduced graphene mixture 112; cooling the doped polyol reduced graphene mixture 114; removing doped polyol reduced graphene from the solution by diluting, centrifuging, and washing to form doped polyol reduced graphene pellet 116; and vacuum drying the doped polyol reduced graphene pellet at a second temperature for a third specified time to obtain doped polyol reduced graphene material 118.

In certain aspects, the cathode material may be co-doped with nitrogen and sulfur. In other aspects, the polyol may be a triethylene glycol. TEG's relatively high boiling point facilitates a one-pot synthesis under reflux conditions. In some aspects, the cathode material is nitrogen and sulfur co-doped triethylene glycol reduced graphene.

In some embodiments, the graphene oxide used has an average molecular weight ranging from about 12,000 g/mol to about 30,000 g/mol. For example, the molecular weight may range from about 13,000 g/mol to about 29,000 g/mol, from about 14,000 g/mol to about 28,000 g/mol, from about 15,000 g/mol to about 27,000 g/mol, from about 16,000 g/mol to about 26,000 g/mol, from about 17,000 g/mol to about 25,000 g/mol, from about 18,000 g/mol to about 24,000 g/mol, from about 19,000 g/mol to about 23,000 g/mol, from about 20,000 g/mol to about 22,000 g/mol, or from about 20,500 to about 21, 500 g/mol.

Referring to step 102 in FIG. 1, the level of dryness or residual moisture in the dried GO may be below 1%. This level of dryness ensures the removal of residual water and prevents potential adverse effects on subsequent steps, such as the dispersion of GO in polyols.

Referring to FIG. 1, polyols in 104 include any suitable solvents with appropriate properties for dispersing GO. Examples include ethylene glycol, propylene glycol, or glycerol. In one embodiment, the polyol is triethylene glycol. The choice of alternative solvent may impact the dispersion quality and stability, so it is important to select a solvent compatible with the synthesis process and desired characteristics of the co-doped polyol reduced cathode material.

Referring to FIG. 1, the dopants in 106 are elements or compounds that may modify the electrochemical property of graphene. For example, dopants include but as not limited to compounds containing nitrogen, sulfur, boron, phosphorous, or transition metals such as iron. Examples of suitable dopants include thiourea, thioacetamide, sodium sulfide, urea, melamine, or combinations thereof. The specific choice of dopants depends on the desired properties and performance requirements of the co-doped triethylene glycol reduced graphene cathode material.

In some embodiments, a combination of chitosan and thiourea may be used as the dopant. The amount of chitosan and thiourea added may be used to control the N/S atomic ratio in the doped polyol reduced graphene. The N/S ratio ranges from about 1:1 to about 5:1. For example, N/S ratio may be about 0.50:1, about 0.75:1, about 0.90:1, about 1:1, about 1.5:1, about 2:1, about 2.5:1, about 3:1, about 3.5:1, about 4:1, about 4.5:1, or about 5:1. The N/S ratio allows tailoring the electrochemical performance of the resulting energy storage device.

Referring to FIG. 1, the pH may be adjusted using an appropriate basic solution. Examples of suitable basic solutions include but are not limited to ammonia, sodium hydroxide, potassium hydroxide, or other alkaline solutions. The specific choice of base depends on factors such as availability, compatibility with the synthesis process, and the desired pH range for achieving electrostatic stabilization of the graphene nanosheets.

The pH may be adjusted from about 7 to about 13, about 7 to about 12, about 7 to about 11, about 8 to about 13, about 8 to about 12, about 8 to about 11, about 9 to about 13, about 9 to about 12, about 9 to about 11, or about 9 to about 10. The pH range provides flexibility in the electrostatic stabilization of graphene nanosheets and ensures optimal conditions for the co-doping process. However, exceeding the upper limit of the pH range may lead to undesired side reactions or affect the stability of the dopants, this it is important to stay within the specified range. The pH may be adjusted to about 8, about 8.2, about 8.4, about 8.6, about 8.8, about 9.0, about 9.2, about 9.4, about 9.6, about 9.8, about 10.0, about 10.2, about 10.4, about 10.6, about 10.8, or about 11.0. In some embodiments, the pH may be from about 9 to about 10.

In some embodiments, an ammonia solution may be used to adjust the pH. The ammonia solution may be about 20% to about 40% ammonia. For example, the ammonia solution may be about 20%, about 25%, about 30%, about 35%, or about 40%. In one embodiment, the ammonia solution may be 30%. The use of ammonia solution in may serve to adjust the pH of the mixture and promote the electrostatic stabilization of the graphene nanosheets. Generally, the concentration of ammonia solution used in such cases may range from about 5% to about 30%, about 5% to about 35%, or about 5% to about 40%. However, the exact amount to use depends on the required pH adjustment and may vary depending on the other components of the mixture.

After the pH of the mixture is adjusted, the mixture may be heated under reflux to a first temperature in an inert atmosphere for a first specified time 110. The first specified temperature ranges from about 270° C. to about 285° C. For example, the temperature may be about 270° C., about 271° C., about 272° C., about 273° C., about 274° C., about 275° C., about 276° C., about 277° C., about 278° C., about 279° C., about 280° C., about 281° C., about 282° C., about 283° C., about 284° C., or about 285° C. In some embodiments, the first temperature may be about 278° C.

In some aspects, the inert atmosphere is one with nitrogen or argon. In some embodiments, the inert atmosphere is an argon atmosphere. Both gases are used as inert atmospheres in various synthesis processes, including the reduction and doping of graphene-based materials. They help prevent oxidation or unwanted reactions during high-temperature processes, ensuring the stability and integrity of the doped triethylene glycol reduced graphene cathode material. The specific choice of inert atmosphere depends on factors such as availability, cost, and compatibility with the synthesis setup.

The first specified time ranges from about 15 minutes to about 120 minutes, about 15 minutes to about 150 minutes, or about 15 minutes to about 180 minutes, about 30 minutes to about 120 minutes, about 30 minutes to about 150 minutes, or about 30 minutes to about 180 minutes, 60 minutes to about 120 minutes, about 60 minutes to about 150 minutes, or about 60 minutes to about 180 minutes. For example, the first specified time may be about 60 minutes, about 65 minutes, 70 minutes, about 75 minutes, about 80 minutes, about 85 minutes, 90 minutes, about 95 minutes, about 100 minutes, about 105 minutes, about 110 minutes, about 115 minutes, or about 120 minutes. In some embodiments, the first specified time may be about 90 minutes.

Referring to FIG. 1, the mixture may be maintained at a second specified time at the first specified temperature 112 to complete the reaction involving reducing the graphene oxide to graphene and doping the graphene with dopants. The second specified time ranges from about 15 minutes to about 60 minutes, about 15 minutes to about 90 minutes, about 15 minutes to about 120 minutes, about 15 minutes to about 150 minutes, or about 15 minutes to about 180 minutes. For example, the second specified time may be about 15 minutes, about 20 minutes, about 25 minutes, about 30 minutes, about 35 minutes, about 40 minutes, 45 minutes, about 50 minutes, about 55 minutes, or about 60 minutes. In some embodiments, the second specified time may be about 30 minutes.

After the formation of doped polyol reduced graphene, the next step of the process includes cooling the mixture 114.

The next steps include diluting, centrifuging, and washing the cooled mixture of doped polyol reduced graphene 116 forming a doped polyol reduced pellet.

The last step of the process includes obtaining the polyol reduced graphene by vacuum drying the pellet at a second temperature for a third specified about of time 118. The second specified temperature ranges from about 50° C. to about 100° C. For example, the temperature may be about 50° C., about 55° C., about 60° C., about 65° C., about 70° C., about 75° C., about 80° C., about 85° C., about 90° C., about 95° C., or about 100° C. In some embodiments, the second temperature may be about 65° C. The third specified time ranges from about 2 hours to about 8 hours. For example, the third specified time may be about 2.0 hours, about 2.5 hours, about 3.0 hours, about 3.5 hours, about 4.0 hours, about 4.5 hours, about 5.0 hours, about 5.5 hours, about 6.0 hours, about 6.5 hours, about 7.0 hours, about 7.5 hours, or about 8.0 hours. In some embodiments, the third specified time may be about 6 hrs.

The yield of the doped polyol reduced graphene pellet ranges from about 65% to about 90%. The yield may range from about 70% to about 90%, about 75% to about 85%, or from about 80% to about 85%. For example, the yield may be about 65%, about 70%, about 75%, about 80%, about 85%, or about 90%. The yield accounts for losses that may occur during the washing, centrifugation, and drying steps. The specific value may vary depending on the efficiency of the purification process and the specific conditions employed. In some embodiments, the yield may be from about 70% to about 80%.

The purity of the doped polyol reduced graphene ranges from about 90% to about 99%. For example, the purity may be about 90%, about 91%, about 92% about 93%, about 94%, about 95%, about 96%, about 97% about 98%, or about 99%. In some embodiments, the purity may be greater than 95%. A high purity may be expected, considering the multiple washing steps and removal of impurities during the synthesis and purification process. Achieving a high purity level is essential to ensure the desired electrochemical performance and minimize any potential adverse effects caused by impurities.

Raman spectra of a reduced graphene oxides may show a shift in the G bands towards lower wavenumbers compared to graphite oxide. This shift may signify a decrease in oxygen content and a restoration of the graphite structure in rGOs. Concurrently, the D band's intensity increases, indicating the creation of new defects during the reduction process. The shift in the G band may suggest a reduction in sp² carbon domains, likely due to the introduction of functional groups or defects. The heightened intensity of the D band may point to an increase in disorder or defects in the carbon lattice, potentially resulting from functionalization or reduction processes. These spectral changes may provide insights into the structural alterations in graphene-based materials during different processing stages.

In one example, XPS elemental scan reveals an increase in oxygen content of about 33%. This increase may result from the introduction of oxygen-containing functional groups including but not limited to hydroxyl, epoxy, carbonyl, carboxyl groups, or triethylene glycol during the oxidation process. This functionalization process may disrupt the sp² carbon network and may introduce sp³ hybridized carbon atoms, leading to changes in the structural and electronic properties of the material.

From a Raman spectroscopy perspective, an increase in oxygen content may lead to the following changes: 1) shift in G band; 2) increase in D band intensity; 3) appearance of D′ band; and 4) broadening and decrease in 2D band intensity. The G band corresponds to the in-plane vibration of sp² carbon atoms and shifts towards higher wavenumbers. The D band is associated with defects and disorder in the carbon lattice and increases in intensity. The D′ band is a defect-induced band like the D band and increases in intensity. This band is often associated with the presence of oxygen-containing functional groups. The 2D band broadens and decreases in intensity. This change is due to the increase in disorder and disruption of the layer structure of graphene. These changes in the Raman spectra may provide insights into the changes in the structural and electronic properties of graphene-based materials due to the increase in oxygen content. They are currently being used to monitor the oxidation process and to optimize the synthesis of graphene-based materials with desired properties.

### Methods of Making Cathode

The present disclosure also includes methods of making cathodes from the cathode materials. The cathode material may be a doped polyol reduced graphene. In other embodiments, the doped polyol reduced graphene may be a nitrogen and sulfur co-doped triethylene glycol reduced graphene described above.

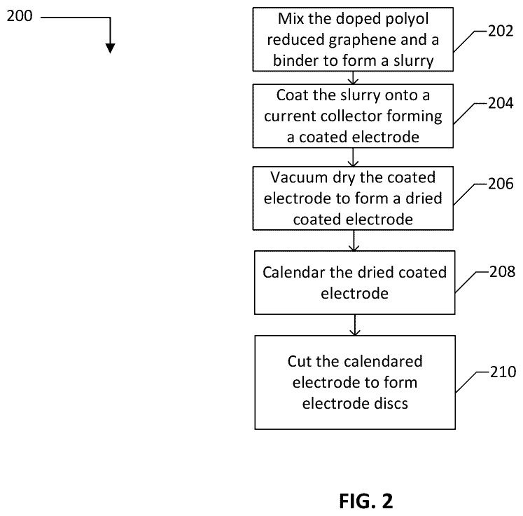

As shown in FIG. 2, the method includes forming a doped polyol reduced graphene material from graphene oxide as described above and in FIG. 1; mixing the doped polyol reduced graphene material and a binder material to form a homogeneous slurry; coating the homogeneous slurry onto a current collector material to form a coated electrode; drying the coated electrode in an oven to form a dried coated electrode; compressing the dried coated electrode to form an electrode with a specified density and a specified thickness; and cutting the electrode with the specified density and the specified thickness using a cutting tool to form the cathode for the energy storage device.

Referring to FIG. 2, the first step includes mixing the doped polyol reduced graphene and a binder to form a homogenous slurry 202. Suitable binders include but are not limited to polyvinyl alcohol (PVA), carboxymethyl cellulose (CMC), polyacrylic acid (PAA), or chitosan. In one embodiment, chitosan is used as the binder.

In some embodiments, the doped polyol reduced graphene may be between about 80 wt % to about 95 wt % of the total electrode mass. For example, the doped polyol reduced graphene may be about 80 wt %, about 81 wt %, about 82 wt %, about 83 wt %, about 84 wt %, about 85 wt %, about 86 wt %, about 87 wt %, about 88 wt %, about 89 wt %, about 90 wt %, about 91 wt %, about 92 wt %, about 93 wt %, about 94 wt %, or about 95 wt % of the total electrode mass. In some embodiments, the doped polyol reduced graphene is 90 wt % of the electrode mass.

The electrode may also include about 0.5-2 wt % chitosan. For example, the chitosan wt % may be about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, or about 2.0 wt %.

The electrode may also include about 10 wt % of other components or additives necessary for the electrode fabrication process. The additional components could include conductive additives, binders, or other materials to optimize the electrode's performance and structural integrity. The exact composition and percentage depend on the specific formulation and optimization for the intended application.

The next step of the process includes coating the slurry onto a current collector 204. The current collector includes but is not limited to aluminum, copper, stainless steel, or nickel. The choice of current collector material may depend on factors such as electrical conductivity, compatibility with the electrode materials, cost, and specific application requirements. The desired properties and performance goals may be considered when selecting the appropriate current collector material. In one embodiment, aluminum is used as the current collector. Any suitable coating technique may be used to coat the current collector. For example, the current collector may be coated using a doctor blade.

Referring to FIG. 2, the next step of the process includes drying the coated electrode in a vacuum oven at a specified temperature for a specified time 206. The coated electrode may be dried at a temperature ranging from about 60° C. to about 90° C. For example, the temperature may be from about 65° C. to about 85° C., about 70° C. to about 80° C., or about 75° C. to about 78° C. In one embodiment, the temperature may be 80° C. The specified about of time for vacuum drying ranges from about 6 hours to about 18 hours. For example, the time may be from about 6.5 hours to about 17.5 hours, about 8.0 hours to about 17 hours, about 8.5 hours to about 16.5 hours, about 9.0 hours to about 16 hours, about 9.5 hours to about 15.5 hours, about 10 hours to about 15 hours, about 10.5 hours to about 14.5 hours, about 11 hours to about 14 hours, about 11.5 hours to about 13.5 hours, or about 12 hours to about 13 hours. In one embodiment, the time may be 12 hours.

Referring to FIG. 2, the next step includes calendaring the dried coated electrodes to achieve the desired thickness and density 208.

The last step of the process involves cutting the calendared electrodes to form electrode discs using a suitable cutting tool 210. For example, suitable cutting tools include disc cutters, punching tools, laser cutting, waterjet cutting, and mechanical cutting tools like rotary cutters or precision blades. The choice depends on precision, throughput, cost, and electrode material characteristics. In one embodiment, a disc cutter may be used as the cutting tool.

### Definitions

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL” The endpoint may also be based on the variability allowed by an appropriate regulatory body, such as the UL, CTIA Authorized Testing Laboratory, etc.

As used herein, “comprises,” “comprising,” “containing,” and “having” and the like may have the meaning ascribed to them in U.S. Patent Law and may mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. In this specification when using an open-ended term, like “comprising” or “including,” it is understood that direct support should be afforded also to “consisting essentially of” language as well as “consisting of” language as if stated explicitly and vice versa.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeably without departing from the teaching of the embodiments and variations herein.

As used herein, the terms “compound” and “component” are used to refer to any type of material, without any loss of generality of the material in question. That is, compound may refer to any element, ion, molecule, complex structure(s), or combinations thereof (e.g. metal oxides, metal sulfides).

As used herein, capacity (mAh) is the total amount of electric charge a battery can store and deliver under specified conditions. It is measured in milliampere-hours (mAh) and represents the product of current (in mA) and time (in hrs) during which the battery can supply that current.

As used herein, Coulombic efficiency (%) is the ratio of the total charge extracted from a battery during discharge to the total charge put into the battery during charge, expressed as a percentage. It indicates the efficiency of the battery in storing and delivering charge.

As used herein, capacity retention (%) is the measure of a battery's ability to retain its original capacity over time and repeated charge/discharge cycles. It is expressed as a percentage of the initial capacity that remains after a certain number of cycles.

As used herein, RCap_Chg (mAh/g) represents the specific charge capacity of the battery during the charging process. It is a measure of the amount of charge a battery can store per unit mass of the active material.

As used herein, RCap_DChg (mAh/g) represents the specific discharge capacity of the battery during the charging process. It indicates the amount of charge the battery can deliver per unit mass of the active material during the discharge process.

As used herein, CC_Chg_Rat (%) is the charge rate under constant current conditions. It indicates the percentage of the nominal capacity that is being charged per hour.

As used herein, REngy_Chg (mWh/g) is the specific energy charged into the battery. It measures the energy stored in the battery per unit mass of the active material during the charging process.

As used herein, State of Health (SoH) (%) is a measure of the overall condition and performance capability of a battery compared to its initial state when it was new. It is expressed as a percentage and indicates how much of the battery's original capacity and performance remain after a period of use or a certain number of cycles. SoH takes into account factors such as capacity fade, internal resistance increase, and other aging effects.

As used herein, cycle ID is the number of complete charge-discharge cycles that have been performed on the battery. A single cycle typically includes on charge phase followed by one discharge phase.

As used herein, step ID refers to the specific phase within a cycle that is being executed. Each step within a cycle is associated with a particular action or condition, such as charging at a constant current, resting, discharging at constant current, etc.

As a person skilled in the art will recognize from the previous detailed description and from the figures and claims, modifications and changes may be made to the embodiments of the invention without departing from the scope of this invention as defined in the following claims.

### EXAMPLES

The following examples illustrate various non-limiting embodiments of the present disclosure.

### Example 1: Synthesis of Co-Doped Triethylene Glycol Reduced Graphene

100 mg of dried graphene oxide (8.33 μmoles) was dispersed in 112 ml of triethylene glycol by ultrasonication for 2-3 hours. 5 mg of chitosan (0.031 moles) and 5 mg (0.066 moles) of thiourea were added to achieve a 1:1 N/S atomic ratio to form a mixture. The pH of the mixture was adjusted to 9-10 using 1.6 ml of 25% ammonia solution. The mixture was heated at approximately 278° C. under reflux conditions in an inert atmosphere (e.g., argon or nitrogen) for 90 minutes, then held at that temperature for an additional 30 minutes. After cooling, the mixture was diluted, centrifuged, and washed multiple times to obtain the sulfur and nitrogen co-doped triethylene glycol reduced graphene pellet, which was then vacuum dried at 65° C. for 6 hours. The yield of the co-doped triethylene glycol reduced pellet was between 70-80%. The purity of the co-doped triethylene glycol reduced pellet was between greater than 95% (e.g., greater than 96%, greater than 97%, greater than 98%, or greater than 99%).

### Example 2—Cathode Fabrication

The desired amount of co-doped TRG to resulting in 90 wt % of the total electrode mass was mixed with a 1 wt % chitosan solution to form a homogeneous slurry. The slurry was coated onto an aluminum current collector using a doctor blade or other coating technique. The coated electrode was dried in a vacuum oven at 80° C. for 12 hours. The dried coated electrode is calendared using a roll press to achieve the desired thickness and density of 200 μm and approximately 1.6 g/cm³ respectively. Electrode discs were cut using a disc cutter.

### Example 3—Characterization of Cathode by Raman Spectroscopy

The co-doped TRG cathode was characterized using the LabRAM HR Evolution Raman Spectroscopy system.

The instrument setup parameters were as follows: Detector: SIN-EM FIUC, StageXY: 75×50 mm Scan+; Objective: x10_VIS; Grating: 600 (500 nm); ND Filter: 25%; Laser: 532_Edge; Hole: 100; Range: Visible; and AFM: Off.

The acquisition options parameters were follows: Delay Time (s): 0; Binning: 1; Readout mode: Signal; Shutter Mode: Always open; Spike Filter: Off; Denoiser: Off; Laser mode: Auto; ICS correction: Off; and Dark Correction: off

The acquisition parameters were as follows: Title: TRG; Spectro (cm⁻¹): 1999.85; RTD time (s): 1; Range: 1300-3000; AE level (cnts): 50000; Autofocus type: Spectral; DuoScan Spot: off; Acq. time (s): 2; Accumulation: 2; Autofocus mode: At Start; and Estimated time: 24 sec.

The Raman spectra obtained from the TRG cathode were analyzed at two different resolutions: 2 μm and 40 μm. At 2 μm resolution, the Raman map provided detailed information about the spatial distribution of the Raman-active modes in the sample. This high-resolution analysis allowed for the identification of regions of the cathode coated with TRG, determination of the uniformity of the TRG coating, and potential identification of areas with different numbers of graphene layers or with defects in the graphene.

At 40 μm resolution, the Raman map provided a more macroscopic view of the sample. While it did not provide the same level of detail about the local properties of the graphene or the cathode as the higher resolution image, it was useful for identifying larger-scale trends or variations in the TRG coating on the cathode.

The Raman spectra obtained from the co-doped TGR cathodes was analyzed at two different resolutions: 2 μm and 40 μm. At 2 μm resolution, the Raman map provided detailed information about the spatial distribution of the Raman-active modes in the sample. This high-resolution analysis allowed for the identification of regions of the cathode coated with TRG, determination of the uniformity of the TRG coating, and potential identification of areas with different numbers of graphene layers or with defects in the graphene. At 40 μm resolution, the Raman map provided a more macroscopic view of the sample. While it did not provide the same level of detail about the local properties of the graphene or the cathode as the higher resolution image, it was useful for identifying larger-scale trends or variations in the TRG coating on the cathode.

### Example 3—Characterization of Cathode by XPS

The co-doped TRG cathode was characterized by XPS. Table 1 below shows the atomic percent of elements in the synthesized co-doped TRG cathode.

TABLE 1
Atomic percent of elements in the
synthesized co-doped TRG cathode.

| Name | Peak BE eV | Height CPS | Area (P) CPS. eV | Atomic % |
|---|---|---|---|---|
| S2p | 162.88 ± 0.1 | 268.21 | 1107.21 ± 0.1 | 0.04 |
| C1s | 285.49 ± 0.1 | 271774.48 | 820282.37 ± 0.1 | 61.85 |
| N1s | 398.66 ± 0.1 | 49070.29 | 103088.31 ± 0.1 | 5.00 |
| O1s | 531.83 ± 0.1 | 478807.24 | 1061980.04 ± 0.1 | 33.11 |

Peak Binding Energy (BE): The uncertainty in the peak binding energy is primarily determined by the precision of the XPS instrument. The ESCALAB™ QXi X-ray Photoelectron Spectrometer (XPS) Microprobe XPS instrument can measure binding energy with an accuracy of ±0.1 eV or better. This precision is achieved through careful calibration of the instrument using reference materials with known binding energies.

Height CPS (Counts Per Second): The height of the peak in an XPS spectrum represents the number of photoelectrons detected at a particular binding energy. The uncertainty in the peak height can be influenced by several factors, including statistical fluctuations in the number of photoelectrons detected, noise in the detector, and variations in the X-ray source intensity. The uncertainty in the peak height could be on the order of a 2-3% percent of the peak height.

FWHM (Full Width at Half Maximum): The FWHM is a measure of the width of the peak in the XPS spectrum, and it provides information about the energy distribution of the photoelectrons. The uncertainty in the FWHM is determined by the quality of the peak fitting, which can be affected by noise in the data and the appropriateness of the peak shape model. Other factors, such as the resolution of the energy analyzer and the natural linewidth of the photoelectron peak, can also contribute to the uncertainty. Therefore, the uncertainty in the FWHM could be on the order of ±0.1 eV.

Area (P) CPS.eV: The area under the peak in the XPS spectrum represents the total number of photoelectrons detected for a particular element, and it is used to determine the elemental composition of the sample. The uncertainty in the peak area can be high, an uncertainty of greater than 20%. This uncertainty is influenced by the same factors as the peak height, as well as uncertainties in the baseline subtraction and the fitting of the peak shape. The peak area may be affected by the sample's surface roughness.

### Example 4-2032 Coin Cells

### Coin Cell Manufacturing

A coin cell was assembled using a TRG electrode, a market-acquired LiFePO₄ electrode, and a LiPF₆ electrolyte in a 2032 form factor coin cell.

The cells were assembled in a nitrogen-filled glove box. This inert environment atmosphere may potentially degrade lithium-based components, typically resulting in reduced performance.

A hydraulic crimper was used to seal the coin cells. Hydraulic crimping may introduce additional stress on the cell components compared to more specialized sealing methods.

### Performance of Coin Cells

The performance of the coin cell was tested using the parameters listed in Table 2.

TABLE 2
Test information to measure performance of the assembled coin cell.
Test Information

| | | | | | |
|---|---|---|---|---|---|
| Start Step | 1 | Cycle | 32 cycle | Record | 5 sec/ |
| | | counts | | Qualification | 10.0 mA/ |
| Voltage | 5 V | Current | +3000/−3000 mA | | 1000.0 mV |
| Measuring- | | Constant | | | |
| range | | | | | |

The step setting scheme used to measure the performance of the assembled coin cell is shown in Table 3.

TABLE 3
Step setting scheme.

| StepNum | StepType | Time(mm:ss) | Vol(V) | Cur(mA) |
|---|---|---|---|---|
| 1 | Rest | 10:00 | | |
| 2 | CC_DChg | | 2.8 | 8.9 |
| 3 | Rest | 10:00 | | |
| 4 | CC_Chg | | 4.3 | 8.9 |
| 5 | CV_Chg | | 4.3 | 0.4 |
| 6 | Rest | 10:00 | | |
| 7 | Cycle | Start Step: 2 | Cycle Total: 30 | |
| 8 | Stop | | | |

The measured raw cycle data is shown in Table 4.

TABLE 4
Cycle data from the coin cell.

| | RCap_{—} | RCap_{—} | | CC_Chg_{—} | |
|---|---|---|---|---|---|
| Cycle | Chg | DChg | Efficiency | Rat | REngy_Chg |
| ID | (mAh/g) | (mAh/g) | (%) | (%) | (mWh/g) |
| 1 | 158 | 139.04 | 88 | 87.56 | 504.4 |
| 2 | 151.9 | 126.73017 | 83.43 | 84.29 | 490.6 |
| 3 | 151.3 | 124.32321 | 82.17 | 77.08 | 486.4 |
| 4 | 151.3 | 123.92983 | 81.91 | 77.08 | 486.6 |
| 5 | 151.3 | 123.24898 | 81.46 | 77.08 | 486.6 |
| 6 | 151.3 | 121.91754 | 80.58 | 77.08 | 483.7 |
| 7 | 151.3 | 121.72085 | 80.45 | 77.08 | 483.3 |
| 8 | 151.1 | 117.1025 | 77.5 | 72.5 | 483.3 |
| 9 | 151.1 | 117.1025 | 77.5 | 72.5 | 483.4 |
| 10 | 151.1 | 117.1025 | 77.5 | 72.5 | 483.4 |
| 11 | 151.1 | 117.1025 | 77.5 | 72.5 | 483.4 |
| 12 | 151.1 | 117.1025 | 77.5 | 72.5 | 480.6 |
| 13 | 151.1 | 117.02695 | 77.45 | 72.5 | 476.9 |
| 14 | 151.1 | 116.73986 | 77.26 | 72.5 | 476.4 |
| 15 | 151.1 | 116.46788 | 77.08 | 72.5 | 475.2 |
| 16 | 151.1 | 116.0448 | 76.8 | 72.5 | 471.1 |
| 17 | 151.1 | 115.5915 | 76.5 | 72.5 | 469.5 |
| 18 | 151.1 | 115.51595 | 76.45 | 72.5 | 465.3 |
| 19 | 151.1 | 115.4404 | 76.4 | 72.5 | 465.3 |
| 20 | 150.9 | 113.49189 | 75.21 | 66.67 | 465.1 |
| 21 | 149.1 | 112.19775 | 75.25 | 72.5 | 457.8 |
| 22 | 147.9 | 111.25038 | 75.22 | 66.67 | 457.4 |
| 23 | 145.1 | 109.18775 | 75.25 | 72.5 | 455.1 |
| 24 | 142.2 | 107.03394 | 75.27 | 66.67 | 451.8 |
| 25 | 140.9 | 105.9568 | 75.2 | 66.67 | 450.4 |
| 26 | 138.5 | 104.0135 | 75.1 | 66.67 | 444.6 |
| 27 | 132.8 | 99.7328 | 75.1 | 66.67 | 437.8 |
| 28 | 130.6 | 98.0806 | 75.1 | 66.67 | 434.9 |
| 29 | 129.9 | 97.5549 | 75.1 | 66.67 | 434.9 |
| 30 | 125.7 | 94.4007 | 75.1 | 66.67 | 428.1 |
| 31 | 122.4 | 91.8 | 75 | 66.67 | 423.7 |
| 32 | 120.9 | 90.54201 | 74.89 | 66.67 | 418.9 |

The measured step data is shown in Table 5.

TABLE 5
Cycle data from the coin cell.

| Cycle ID | Step ID | Step Type | Start Vol(mV) | End Vol(mV) |
|---|---|---|---|---|
| 1 | 1 | Rest | 3590.2 | 3540.8 |
| 1 | 2 | CC_DChg | 3537.8 | 2822.6 |
| 1 | 3 | Rest | 2822.6 | 2848.6 |
| 2 | 4 | CC_Chg | 2897.8 | 4297.5 |
| 2 | 5 | CV_Chg | 4299.3 | 4299.3 |
| 2 | 6 | Rest | 4298.9 | 4256.7 |
| 2 | 7 | CC_DChg | 4250.3 | 2799.5 |
| 2 | 8 | Rest | 2800.2 | 2892.1 |
| 3 | 9 | CC_Chg | 2897.8 | 4297.8 |
| 3 | 10 | CV_Chg | 4299.3 | 4299.3 |
| 3 | 11 | Rest | 4296.3 | 4284.5 |
| 3 | 12 | CC_DChg | 4280.5 | 2819.6 |
| 3 | 13 | Rest | 2807.3 | 2850.8 |
| 4 | 14 | CC_Chg | 2857.8 | 4297.8 |
| 4 | 15 | CV_Chg | 4300.2 | 4300.2 |
| 4 | 16 | Rest | 4289.9 | 4276.6 |
| 4 | 17 | CC_DChg | 4280.5 | 2807.3 |
| 4 | 18 | Rest | 2807.3 | 2819.2 |
| 5 | 19 | CC_Chg | 2819.2 | 4297.5 |
| 5 | 20 | CV_Chg | 4300.2 | 4300.2 |
| 5 | 21 | Rest | 4300.2 | 4256.3 |
| 5 | 22 | CC_DChg | 4256.3 | 2809.6 |
| 5 | 23 | Rest | 2809.6 | 2865.2 |
| 6 | 24 | CC_Chg | 2865.2 | 4297.8 |
| 6 | 25 | CV_Chg | 4299.3 | 4299.3 |
| 6 | 26 | Rest | 4299.3 | 4243.3 |
| 6 | 27 | CC_DChg | 4243.3 | 2810.2 |
| 6 | 28 | Rest | 2810.2 | 2849.5 |
| 7 | 29 | CC_Chg | 2849.5 | 4297.8 |
| 7 | 30 | CV_Chg | 4299.3 | 4299.3 |
| 7 | 31 | Rest | 4299.3 | 4240.6 |
| 7 | 32 | CC_DChg | 4240.6 | 2805.7 |
| 7 | 33 | Rest | 2805.7 | 2858.9 |
| 8 | 34 | CC_Chg | 2858.9 | 4297.8 |
| 8 | 35 | CV_Chg | 4299.3 | 4299.3 |
| 8 | 36 | Rest | 4299.3 | 4254.9 |
| 8 | 37 | CC_DChg | 4254.9 | 2801.9 |
| 8 | 38 | Rest | 2801.9 | 2852.7 |
| 9 | 39 | CC_Chg | 2852.7 | 4297.8 |
| 9 | 40 | CV_Chg | 4299.3 | 4299.3 |
| 9 | 41 | Rest | 4299.3 | 4262.9 |
| 9 | 42 | CC_DChg | 4262.9 | 2800.1 |
| 9 | 43 | Rest | 2800.1 | 2873.8 |
| 10 | 44 | CC_Chg | 2873.8 | 4297.8 |
| 10 | 45 | CV_Chg | 4299.3 | 4299.3 |
| 10 | 46 | Rest | 4299.3 | 4268.5 |
| 10 | 47 | CC_DChg | 4268.5 | 2800.8 |
| 10 | 48 | Rest | 2800.8 | 2869.3 |
| 11 | 49 | CC_Chg | 2869.3 | 4297.8 |
| 11 | 50 | CV_Chg | 4299.3 | 4299.3 |
| 11 | 51 | Rest | 4299.3 | 4272.2 |
| 11 | 52 | CC_DChg | 4272.2 | 2800.6 |
| 11 | 53 | Rest | 2800.6 | 2832 |
| 12 | 54 | CC_Chg | 2832 | 4297.8 |
| 12 | 55 | CV_Chg | 4299.3 | 4299.3 |
| 12 | 56 | Rest | 4299.3 | 4276 |
| 12 | 57 | CC_DChg | 4276 | 2800.2 |
| 12 | 58 | Rest | 2800.2 | 2831.9 |
| 13 | 59 | CC_Chg | 2831.9 | 4297.8 |
| 13 | 60 | CV_Chg | 4299.3 | 4299.3 |
| 13 | 61 | Rest | 4299.3 | 4277.2 |
| 13 | 62 | CC_DChg | 4277.2 | 2800.2 |
| 13 | 63 | Rest | 2800.2 | 2846.3 |
| 14 | 64 | CC_Chg | 2846.3 | 4297.8 |
| 14 | 65 | CV_Chg | 4299.3 | 4299.3 |
| 14 | 66 | Rest | 4299.3 | 4267.2 |
| 14 | 67 | CC_DChg | 4267.2 | 2799.6 |
| 14 | 68 | Rest | 2799.6 | 2852.9 |
| 15 | 69 | CC_Chg | 2852.9 | 4297.8 |
| 15 | 70 | CV_Chg | 4299.3 | 4299.3 |
| 15 | 71 | Rest | 4299.3 | 4278.1 |
| 15 | 72 | CC_DChg | 4278.1 | 2799.2 |
| 15 | 73 | Rest | 2799.2 | 2854.7 |
| 16 | 74 | CC_Chg | 2854.7 | 4298.1 |
| 16 | 75 | CV_Chg | 4299.3 | 4299.3 |
| 16 | 76 | Rest | 4299.3 | 4278.1 |
| 16 | 77 | CC_DChg | 4278.1 | 2800.1 |
| 16 | 78 | Rest | 2800.1 | 2857.3 |
| 17 | 79 | CC_Chg | 2857.3 | 4298.9 |
| 17 | 80 | CV_Chg | 4299.3 | 4299.3 |
| 17 | 81 | Rest | 4299.3 | 4277.8 |
| 17 | 82 | CC_DChg | 4277.8 | 2800.6 |
| 17 | 83 | Rest | 2800.6 | 2830.6 |
| 18 | 84 | CC_Chg | 2830.6 | 4299.3 |
| 18 | 85 | CV_Chg | 4299.3 | 4299.3 |
| 18 | 86 | Rest | 4299.3 | 4277.5 |
| 18 | 87 | CC_DChg | 4277.5 | 2797.6 |
| 18 | 88 | Rest | 2797.6 | 2831.8 |
| 19 | 89 | CC_Chg | 2831.8 | 4299.3 |
| 19 | 90 | CV_Chg | 4299.3 | 4299.3 |
| 19 | 91 | Rest | 4299.3 | 4275.3 |
| 19 | 92 | CC_DChg | 4275.3 | 2800.8 |
| 19 | 93 | Rest | 2800.8 | 2834.3 |
| 20 | 94 | CC_Chg | 2834.3 | 4299.3 |
| 20 | 95 | CV_Chg | 4299.3 | 4299.3 |
| 20 | 96 | Rest | 4299.3 | 4275 |
| 20 | 97 | CC_DChg | 4275 | 2798.6 |
| 20 | 98 | Rest | 2798.6 | 2856.1 |
| 21 | 99 | CC_Chg | 2856.1 | 4299.1 |
| 21 | 100 | CV_Chg | 4299.3 | 4299.3 |
| 21 | 101 | Rest | 4299.3 | 4272.9 |
| 21 | 102 | CC_DChg | 4272.9 | 2800.7 |
| 21 | 103 | Rest | 2800.7 | 2833.3 |
| 22 | 104 | CC_Chg | 2833.3 | 4299.1 |
| 22 | 105 | CV_Chg | 4299.3 | 4299.3 |
| 22 | 106 | Rest | 4299.3 | 4270.1 |
| 22 | 107 | CC_DChg | 4270.1 | 2800.1 |
| 22 | 108 | Rest | 2800.1 | 2857.3 |
| 23 | 109 | CC_Chg | 2857.3 | 4297.8 |
| 23 | 110 | CV_Chg | 4299.3 | 4299.3 |
| 23 | 111 | Rest | 4299.3 | 4268.5 |
| 23 | 112 | CC_DChg | 4268.5 | 2795.3 |
| 23 | 113 | Rest | 2795.3 | 2842.7 |
| 24 | 114 | CC_Chg | 2842.7 | 4297.6 |
| 24 | 115 | CV_Chg | 4299.3 | 4299.3 |
| 24 | 116 | Rest | 4299.3 | 4265.7 |
| 24 | 117 | CC_DChg | 4265.7 | 2801.6 |
| 24 | 118 | Rest | 2801.6 | 2862.1 |
| 25 | 119 | CC_Chg | 2862.1 | 4299.3 |
| 25 | 120 | CV_Chg | 4299.3 | 4299.3 |
| 25 | 121 | Rest | 4299.3 | 4263.6 |
| 25 | 122 | CC_DChg | 4263.6 | 2797.3 |
| 25 | 123 | Rest | 2797.3 | 2830.6 |
| 26 | 124 | CC_Chg | 2830.6 | 4299.3 |
| 26 | 125 | CV_Chg | 4299.3 | 4299.3 |
| 26 | 126 | Rest | 4299.3 | 4259.8 |
| 26 | 127 | CC_DChg | 4259.8 | 2798.4 |
| 26 | 128 | Rest | 2798.4 | 2828.4 |
| 27 | 129 | CC_Chg | 2828.4 | 4298.1 |
| 27 | 130 | CV_Chg | 4299.3 | 4299.3 |
| 27 | 13 | Rest | 4299.3 | 4255.2 |
| 27 | 132 | CC_DChg | 4255.2 | 2800.8 |
| 27 | 133 | Rest | 2800.8 | 2834.7 |
| 28 | 134 | CC_Chg | 2834.7 | 4298.9 |
| 28 | 135 | CV_Chg | 4299.3 | 4299.3 |
| 28 | 136 | Rest | 4299.3 | 4249 |
| 28 | 137 | CC_DChg | 4249 | 2800.5 |
| 28 | 138 | Rest | 2800.5 | 2839.1 |
| 29 | 139 | CC_Chg | 2839.1 | 4299.2 |
| 29 | 140 | CV_Chg | 4299.3 | 4299.3 |
| 29 | 141 | Rest | 4299.3 | 4241.2 |
| 29 | 142 | CC_DChg | 4241.2 | 2800.9 |
| 29 | 143 | Rest | 2800.9 | 2832.3 |
| 30 | 144 | CC_Chg | 2832.3 | 4297.6 |
| 30 | 145 | CV_Chg | 4299.3 | 4299.3 |
| 30 | 146 | Rest | 4299.3 | 4235.3 |
| 30 | 147 | CC_DChg | 4235.3 | 2800.1 |
| 30 | 148 | Rest | 2800.1 | 2845.1 |
| 31 | 149 | CC_Chg | 2845.1 | 4297.1 |
| 31 | 150 | CV_Chg | 4299.3 | 4299.3 |
| 31 | 151 | Rest | 4299.3 | 4226 |
| 31 | 152 | CC_DChg | 4226 | 2789.6 |
| 31 | 153 | Rest | 2789.6 | 2844.9 |
| 32 | 154 | CC_Chg | 2844.9 | 4299.5 |
| 32 | 155 | CV_Chg | 4299.6 | 4299.6 |
| 32 | 156 | Rest | 4299.6 | 4213.3 |

The start voltage, mid-voltage, and end voltage of the CC_DChg step is shown in Table 6.

TABLE 6
Start voltage, mid-voltage, and end voltage of the CC_DChg step

| Step ID | Step Type | Start Vol(mV) | End Vol(mV) | Mid Vol (mV) |
|---|---|---|---|---|
| 2 | CC_DChg | 3537.8 | 2822.6 | 3180.2 |
| 7 | CC_DChg | 4250.3 | 2799.5 | 3524.9 |
| 12 | CC_DChg | 4280.5 | 2819.6 | 3550.05 |
| 17 | CC_DChg | 4280.5 | 2807.3 | 3543.9 |
| 22 | CC_DChg | 4256.3 | 2809.6 | 3532.95 |
| 27 | CC_DChg | 4243.3 | 2810.2 | 3526.75 |
| 32 | CC_DChg | 4240.6 | 2805.7 | 3523.15 |
| 37 | CC_DChg | 4254.9 | 2801.9 | 3528.4 |
| 42 | CC_DChg | 4262.9 | 2800.1 | 3531.5 |
| 47 | CC_DChg | 4268.5 | 2800.8 | 3534.65 |
| 52 | CC_DChg | 4272.2 | 2800.6 | 3536.4 |
| 57 | CC_DChg | 4276 | 2800.2 | 3538.1 |
| 62 | CC_DChg | 4277.2 | 2800.2 | 3538.7 |
| 67 | CC_DChg | 4267.2 | 2799.6 | 3533.4 |
| 72 | CC_DChg | 4278.1 | 2799.2 | 3538.65 |
| 77 | CC_DChg | 4278.1 | 2800.1 | 3539.1 |
| 82 | CC_DChg | 4277.8 | 2800.6 | 3539.2 |
| 87 | CC_DChg | 4277.5 | 2797.6 | 3537.55 |
| 92 | CC_DChg | 4275.3 | 2800.8 | 3538.05 |
| 97 | CC_DChg | 4275 | 2798.6 | 3536.8 |
| 102 | CC_DChg | 4272.9 | 2800.7 | 3536.8 |
| 107 | CC_DChg | 4270.1 | 2800.1 | 3535.1 |
| 112 | CC_DChg | 4268.5 | 2795.3 | 3531.9 |
| 117 | CC_DChg | 4265.7 | 2801.6 | 3533.65 |
| 122 | CC_DChg | 4263.6 | 2797.3 | 3530.45 |
| 127 | CC_DChg | 4259.8 | 2798.4 | 3529.1 |
| 132 | CC_DChg | 4255.2 | 2800.8 | 3528 |
| 137 | CC_DChg | 4249 | 2800.5 | 3524.75 |
| 142 | CC_DChg | 4241.2 | 2800.9 | 3521.05 |
| 147 | CC_DChg | 4235.3 | 2800.1 | 3517.7 |
| 152 | CC_DChg | 4226 | 2789.6 | 3507.8 |

The nominal voltage was determined to be 3520.93 mV by calculating the average of the mid voltage in the CC_DChg step shown in Table 6.

The raw data shown in Tables 4-5 was analyzed using the equations listed in Table 7 to determine the capacity (mAh), charge time (hrs), capacity retention (%), capacity fade (mAh/g), coulombic efficiency (%), and state of health (SoH). As shown in Table 7, capacity was determined by multiplying the specific capacity with the mass of the active material. The charging current used for the analysis was 8.9 mA. The amount of active material in electrode was 0.3 g.

TABLE 7
Equations used to determine the coin cell properties.

| Capacity (mAh) | RCap (mAh/g) × mass (g) of Active Material |
|---|---|
| | in the electrode |
| Charge/Discharge | Capacity (mAh)/Charge or Discharge Current |
| Time (hrs) | (mA) |
| Capacity Retention | RCap_DChg (Cycle N)/Rcap_DChg (Cycle |
| (%) | 1) × 100% |
| Capacity Fade | RCap_DChg (Cycle 1) − RCap_DChg |
| (mAh/g) | (Cycle N) |
| Coulombic Efficiency | RCap_DChg/RCap_Chg × 100% |
| (%) | |
| State of Health | Capacity (Cycle N)/Capacity (Cycle 1) × |
| (SoH) (%) | 100% |

Table 8 shows the results of the analysis of the raw data in Tables 4 and 5 using the formulae in Table 6.

TABLE 8
Properties of the coin cell with the TRG electode.

| | | Charge | Capacity | Capacity | Coulombic | State of |
|---|---|---|---|---|---|---|
| Cycle | Capacity | Time | Retention | Fade | Efficiency | Health |
| ID | (mAh) | (hrs) | (%) | (mAh/g) | (%) | (SoH) (%) |
| 1 | 47.4 | 5.325842697 | 100 | 0 | 88 | 100 |
| 2 | 45.57 | 5.120224719 | 91.14655495 | 12.30983 | 83.43 | 96.13924051 |
| 3 | 45.39 | 5.1 | 89.41542722 | 14.71679 | 82.17 | 95.75949367 |
| 4 | 45.39 | 5.1 | 89.13250144 | 15.11017 | 81.91 | 95.75949367 |
| 5 | 45.39 | 5.1 | 88.64282221 | 15.79102 | 81.46 | 95.75949367 |
| 6 | 45.39 | 5.1 | 87.68522727 | 17.12246 | 80.58 | 95.75949367 |
| 7 | 45.39 | 5.1 | 87.54376438 | 17.31915 | 80.45 | 95.75949367 |
| 8 | 45.33 | 5.093258427 | 84.22216628 | 21.9375 | 77.5 | 95.63291139 |
| 9 | 45.33 | 5.093258427 | 84.22216628 | 21.9375 | 77.5 | 95.63291139 |
| 10 | 45.33 | 5.093258427 | 84.22216628 | 21.9375 | 77.5 | 95.63291139 |
| 11 | 45.33 | 5.093258427 | 84.22216628 | 21.9375 | 77.5 | 95.63291139 |
| 12 | 45.33 | 5.093258427 | 84.22216628 | 21.9375 | 77.5 | 95.63291139 |
| 13 | 45.33 | 5.093258427 | 84.1678294 | 22.01305 | 77.45 | 95.63291139 |
| 14 | 45.33 | 5.093258427 | 83.96134925 | 22.30014 | 77.26 | 95.63291139 |
| 15 | 45.33 | 5.093258427 | 83.76573648 | 22.57212 | 77.08 | 95.63291139 |
| 16 | 45.33 | 5.093258427 | 83.46144994 | 22.9952 | 76.8 | 95.63291139 |
| 17 | 45.33 | 5.093258427 | 83.13542865 | 23.4485 | 76.5 | 95.63291139 |
| 18 | 45.33 | 5.093258427 | 83.08109177 | 23.52405 | 76.45 | 95.63291139 |
| 19 | 45.33 | 5.093258427 | 83.02675489 | 23.5996 | 76.4 | 95.63291139 |
| 20 | 45.27 | 5.086516854 | 81.62535242 | 25.54811 | 75.21 | 95.50632911 |
| 21 | 44.73 | 5.025842697 | 80.69458429 | 26.84225 | 75.25 | 94.36708861 |
| 22 | 44.37 | 4.985393258 | 80.01321922 | 27.78962 | 75.22 | 93.60759494 |
| 23 | 43.53 | 4.891011236 | 78.52973964 | 29.85225 | 75.25 | 91.83544304 |
| 24 | 42.66 | 4.793258427 | 76.98068182 | 32.00606 | 75.27 | 90 |
| 25 | 42.27 | 4.749438202 | 76.20598389 | 33.0832 | 75.2 | 89.17721519 |
| 26 | 41.55 | 4.668539326 | 74.80832854 | 35.0265 | 75.1 | 87.65822785 |
| 27 | 39.84 | 4.476404494 | 71.72957422 | 39.3072 | 75.1 | 84.05063291 |
| 28 | 39.18 | 4.402247191 | 70.54128308 | 40.9594 | 75.1 | 82.65822785 |
| 29 | 38.97 | 4.378651685 | 70.16319045 | 41.4851 | 75.1 | 82.21518987 |
| 30 | 37.71 | 4.237078652 | 67.89463464 | 44.6393 | 75.1 | 79.55696203 |
| 31 | 36.72 | 4.125842697 | 66.02416571 | 47.24 | 75 | 77.46835443 |
| 32 | 36.27 | 4.075280899 | 65.1193973 | 48.49799 | 74.89 | 76.51898734 |

The average capacity of the coin cell was calculated by taking the average of all the cell capacities in Table 8. The average coin cell capacity was 43.65 mAh.

The average charge time of the coin cell was calculated by taking the average of all the charge times in Table 8. The average charge time was 4.91 hrs.

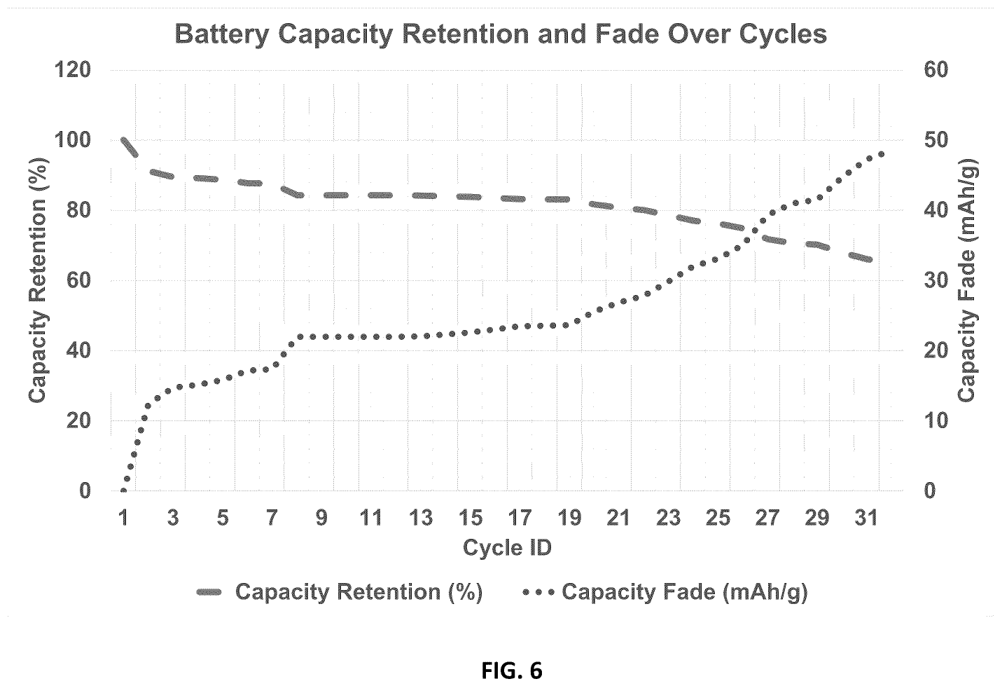

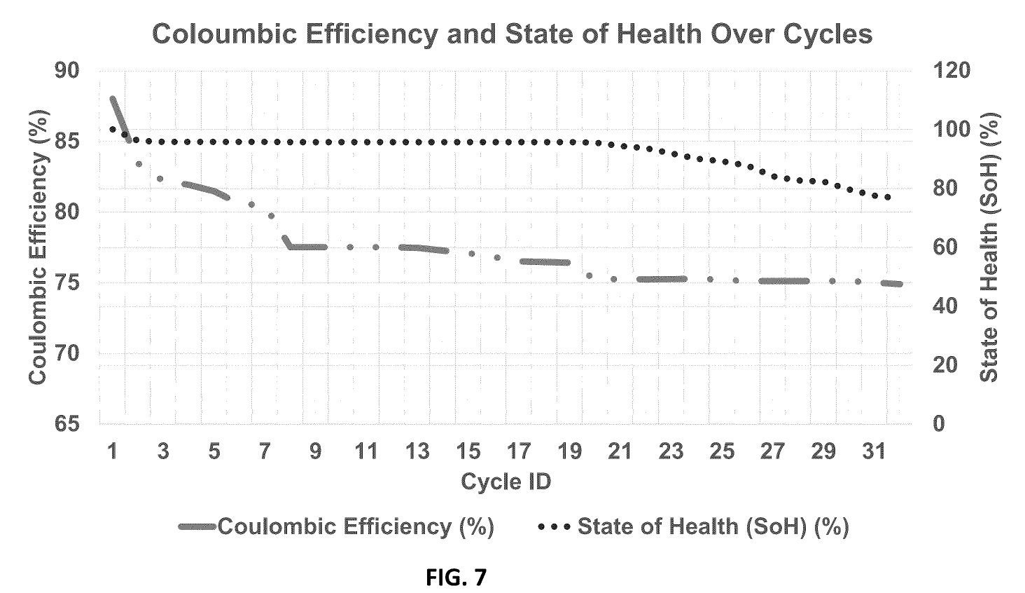

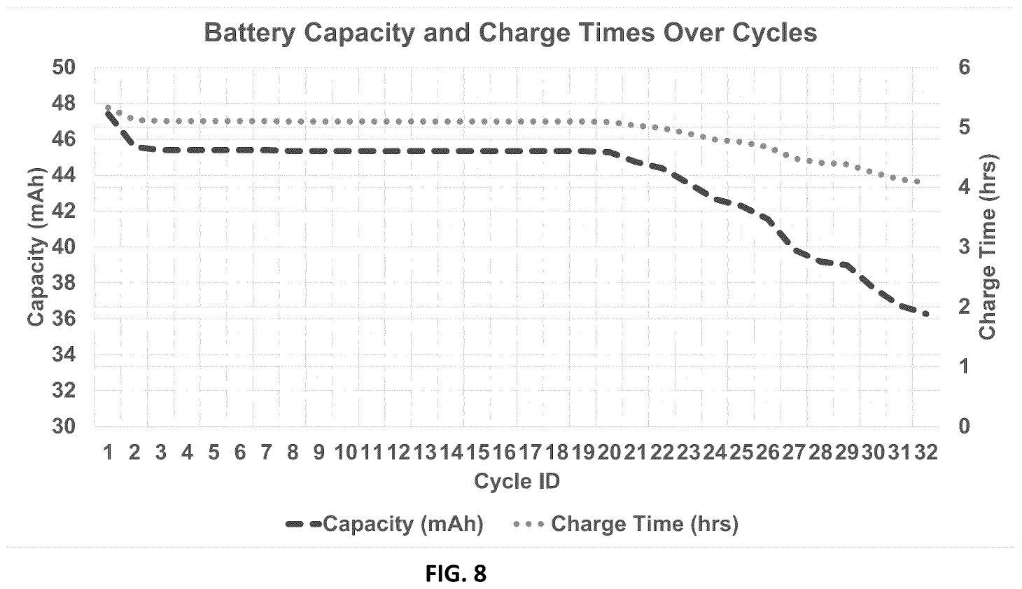

The analyzed data in Table 8 is represented graphically in FIGS. 6-8. FIG. 6 represents line plots showing capacity retention (%) vs. cycle and capacity fade (mAh/g) vs. cycle of the coin cell. FIG. 7 represents line plots showing coulombic efficiency (%) vs. cycle and state of health (SoH) (%) vs. cycle of the coin cell. FIG. 8 represents line plots showing capacity (mAh) vs. cycle and charge time (hours) vs. cycle of the coin cell.

The coin cell achieved a voltage 4.3 V, which is significantly higher than the typical 3.6 V of conventional lithium-ion cells. This higher voltage potentially allows for more efficient energy storage and use.

The coin cell achieved an energy density of 504.4 Wh/kg, a substantial improvement over conventional lithium-based cells, which typically offer 200-300 Wh/kg. The coin cells demonstrated an increase in energy density of 68-169% compared to conventional technology.

The coin cell demonstrated a capacity of 43.65 mAh. The achieved capacity significantly outperformed the state-of-the-art based coin cells, which typically offer only around 30 mAh.

Despite the manufacturing conditions stated above, the inventive TRG electrodes demonstrated superior performance, underscoring the robustness and potential of our technology. The versatility shown by both electrode configurations suggests broad potential applications.

### Example 5—Assemble a Battery Using the Disclosed Electrodes

To assemble a battery using NSPG and TRG graphene-based electrodes, the dual-ion concept will be leveraged, which involves the simultaneous intercalation of both cations and anions into the electrodes during charge and discharge cycles. This approach is critical for enhancing the energy density and cycling stability of the battery. The electrochemical aspect of this assembly is central to its performance, and the choice of electrolyte and additives will play a significant role.

For optimal performance, it is intended to utilize ionic liquid electrolytes due to their high electrochemical stability and non-flammability. Specifically, 1-butyl-1-methylpyrrolidinium bis(trifluoromethylsulfonyl)imide (Pyr14TFSI) will be selected, an ionic liquid electrolyte, known for its extended anodic stability and reduced risk of solvent co-intercalation at high potentials. However, Pyr14TFSI alone can cause issues such as graphene exfoliation when used with graphene anodes, leading to poor overall performance. To mitigate this issue, certain additives that form a stable solid electrolyte interphase (SEI) on the graphene surface will be incorporated.

Fluoroethylene carbonate (FEC), a carbonate additive, and ethylene sulfite (ES), a sulfite additive, will be key additives to enhance the performance of the Pyr14TFSI electrolyte in DCBs. FEC is highly effective in improving the electrochemical stability of the electrolyte. During the initial charging cycles, FEC will decompose to form a stable and robust SEI layer on the anode's surface. This SEI layer will prevent further electrolyte decomposition, reduce side reactions, and enhance overall cycling stability. FEC is particularly beneficial for high-voltage applications as it maintains the integrity of the electrode materials and minimizes capacity fade over extended cycling.

Similarly, ES will decompose to form a protective SEI on the electrode surfaces, stabilizing the electrolyte and preventing detrimental side reactions. ES is especially effective in improving the low-temperature performance of batteries and increasing their overall efficiency. By incorporating ES into the electrolyte, the reversible capacity and cycling stability of the battery will be significantly improved.

In addition to these non-salt additives, certain salt additives will also be used to further enhance the electrolyte's performance. Salts such as lithium bis(trifluoromethanesulfonyl)imide (LiTFSI), a lithium salt, and lithium hexafluorophosphate (LiPF6), another lithium salt, will help maintain high ionic conductivity and stability of the electrolyte, crucial for the efficient operation of the battery. These salts will support the dual-ion intercalation process by providing a stable ionic environment for both cations and anions.

In the electrochemical operation of our dual carbon battery, the NSPG and TRG graphene-based electrodes will work synergistically to facilitate the dual-ion concept. During the charging process, cations (such as Li+) will intercalate into the NSPG electrode, while anions (such as TFSI- or PF6-) will intercalate into the TRG electrode. This simultaneous intercalation increases the energy storage capacity of the battery by utilizing both electrodes for ion storage. The use of Pyr14TFSI, enhanced with FEC and ES, will ensure that these intercalation processes occur efficiently and stably, even at high voltages.

The enhanced SEI layers formed by FEC and ES additives will protect the electrode materials from degradation, thereby improving the cycle life of the battery. These SEI layers will also reduce the overall impedance of the battery, leading to higher Coulombic efficiency and better power performance. The inclusion of LiTFSI or LiPF₆ salts will further improve the ionic conductivity of the electrolyte, ensuring rapid ion transport and reducing polarization during high-rate cycling.

Overall, by carefully selecting and optimizing the electrolyte and additives, the assembled DCB should achieve superior electrochemical performance. This will include high energy density, excellent cycling stability, and robust safety characteristics, making it a viable and efficient energy storage solution leveraging the dual-ion intercalation concept.

Numerous examples are provided herein to enhance the understanding of the present disclosure. A specific set of statements are provided as follows.

Statement 1: Acathode material comprising a polyol reduced graphene and a plurality of dopants.

Statement 2: The cathode material of statement 1, wherein the plurality of dopants is incorporated into the graphene.

Statement 3: The cathode material of statement 1, wherein the polyol comprises ethylene glycol, glycerol, triethylene glycol (TEG), or combinations thereof.

Statement 4: The cathode material of statement 3, wherein the polyol is triethylene glycol.

Statement 5: The cathode material of statement 1, wherein the plurality of dopants comprise nitrogen, sulfur, boron, phosphorous, iron, or a combination thereof.

Statement 6: The cathode material of statement 5, wherein the plurality of dopants is a co-dopant comprising nitrogen and sulfur.

Statement 7: The cathode material of statement 6, wherein the nitrogen is derived from a nitrogen containing polyvinyl alcohol, polyacrylic acid, or combinations thereof.

Statement 8: The cathode material of statement 7, wherein the nitrogen is derived from chitosan.

Statement 9: The cathode material of statement 6, wherein the sulfur is derived from thioacetamide, sodium sulfide, elemental sulfur, thiourea, or combinations thereof.

Statement 10: The cathode material of statement 1, wherein the cathode material formula is CₓH_{y}O_{z}NₘSₙ, wherein x, y, z, m, and n are integers or decimal numbers; where x is about 1 to about 10, y is about 1 to about 20, z is about 0 to about 5, m is greater than 0 to about 5, and n is greater than 0 to about 5.

Statement 11: The cathode material of statement 1, wherein the cathode material formula is CₓH_{y}O_{z}NₘSₙ, wherein x, y, z, m, and n are integers or decimal numbers; where x is about 2 to about 8, y is about 5 to about 15, z is about 2 to about 4, m is greater than 2 to about 4, and n is greater than 2 to about 4.

Statement 12: The cathode material of statement 1, wherein the cathode material formula is CₓH_{y}O_{z}NₘSₙ, wherein x, y, z, m, and n are integers or decimal numbers; where x is about 4 to about 6, y is about 5 to about 15, z is about 2 to about 4, m is greater than 2 to about 4, and n is greater than 2 to about 4.

Statement 13: The cathode material of statement 1, wherein the cathode material formula is CₓH_{y}O_{z}NₘSₙ, wherein x, y, z, m, and n are integers or decimal numbers; where x is about 2 to about 8, y is about 10 to about 12, z is about 2 to about 4, m is greater than 2 to about 4, and n is greater than 2 to about 4.

Statement 14: The cathode material of statement 10, wherein the formula is C₆H₄N₂S or C₅H₁₀ O₃N₃S₃.

Statement 15: The cathode material of statement 10, wherein nitrogen to sulfur atomic ratio (N/S) is varied to optimize electrochemical performance of the cathode material in energy storage applications.

Statement 16: The cathode material of statement 15, wherein the N/S ratio ranges from about 1:1 to about 3:1.

Statement 17: The cathode material of statement 1, wherein cathode material of has a specific capacity ranging from between 200 mAh/g to 750 mAh/g.

Statement 18: The cathode material of statement 17, wherein cathode material of has a specific capacity ranging from between 280 mAh/g to 450 mAh/g.

Statement 19: The cathode material of statement 17, wherein cathode material of has a specific capacity ranging from between 350 mAh/g to 600 mAh/g.

Statement 20: The cathode material of statement 17, wherein cathode material of has a specific capacity ranging from between 420 mAh/g to 750 mAh/g.

Statement 21: The cathode material of statement 17, wherein the cathode material has a specific capacity ranging from between 200 to 300 mAh/g.

Statement 22: The cathode material of statement 1, wherein the cathode material has an energy density ranging from greater than 500 to 2500 Wh/kg.

Statement 23: The cathode material of statement 1, wherein the cathode material has an energy density ranging from 800 to 1500 Wh/kg.

Statement 24: The cathode material of statement 1, wherein the cathode material has an energy density ranging from 1000 to 2000 Wh/kg.

Statement 25: The cathode material of statement 1, wherein the cathode material has an energy density ranging from 1200 to 2500 Wh/kg.

Statement 26: The cathode material of statement 1, wherein the cathode material has an energy density ranging from 600 to 800 Wh/kg.

Statement 27: The cathode material of statement 1, wherein the cathode material has an energy density ranging from 510 to 700 Wh/kg.

Statement 28: A composition comprising a graphene doped with nitrogen and sulfur.

Statement 29: The composition of statement 28, wherein the composition further comprises a polyol.

Statement 30: The composition of statement 28, wherein the graphene doped with nitrogen and sulfur is suitable for use as a cathode material.

Statement 31: The composition of statement 28, wherein the composition further comprises chitosan.

Statement 32: A battery comprising an anode, a cathode, an electrolyte, and a separator, wherein the cathode comprises the cathode material of statements 1-27.

Statement 33: The battery of statement 32, wherein the battery has a capacity retention of over 80%.

Statement 34: The battery of statement 32, wherein the battery of has a specific capacity ranging from between 200 mAh/g to 750 mAh/g.

Statement 35: The battery of statement 34, wherein the battery of has a specific capacity ranging from between 280 mAh/g to 450 mAh/g.

Statement 36: The battery of statement 34, wherein the battery of has a specific capacity ranging from between 350 mAh/g to 600 mAh/g.

Statement 37: The battery of statement 34, wherein the battery of has a specific capacity ranging from between 420 mAh/g to 750 mAh/g.

Statement 38: The battery of statement 34, wherein the battery has a specific capacity ranging from between 200 to 300 mAh/g.

Statement 39: The battery of statement 32, wherein the battery has an energy density ranging from greater than 500 to 2500 Wh/kg.

Statement 40: The battery of statement 39, wherein the battery has an energy density ranging from 800 to 1500 Wh/kg.

Statement 41: The battery of statement 39, wherein the battery has an energy density ranging from 1000 to 2000 Wh/kg.

Statement 42: The battery of statement 39, wherein the battery has an energy density ranging from 1200 to 2500 Wh/kg.

Statement 43: The battery of statement 39, wherein the battery has an energy density ranging from 600 to 800 Wh/kg.

Statement 44: The battery of statement 39, wherein the battery has an energy density ranging from 510 to 700 Wh/kg.

Statement 45: A method of producing a cathode for energy storage applications, the method comprising: forming a co-doped polyol reduced graphene material from graphene oxide, a polyol, and a plurality of dopants; mixing the co-doped polyol reduced graphene material and a binder material to form a homogeneous slurry; coating the homogeneous slurry onto a current collector material to form a coated electrode; drying the coated electrode in an oven to form a dried coated electrode; compressing the dried coated electrode to form an electrode with a specified density and a specified thickness; and cutting the electrode with the specified density and the specified thickness using a cutting tool to form the cathode for the energy storage applications.

Statement 46: The method of statement 45, wherein the polyol comprises ethylene glycol, glycerol, triethylene glycol, or combinations thereof.

Statement 47: The method of statement 45, wherein the plurality of dopants comprise nitrogen, sulfur, boron, phosphorous, iron, or a combination thereof.

Statement 48: The method of statement 45, wherein the co-dopant is nitrogen and sulfur.

Statement 49: The method of statement 48, wherein the nitrogen is derived from a nitrogen containing polyvinyl alcohol, polyacrylic acid, thiourea, melamine, or combinations thereof.

Statement 50: The method of statement 49, wherein the nitrogen is derived from chitosan.

Statement 51: The method of statement 48, wherein the sulfur is derived from thioacetamide, sodium sulfide, elemental sulfur, thiourea, or combinations thereof.

Statement 52: The method of statement 45, wherein the forming a co-doped polyol reduced graphene step comprises forming a co-doped triethylene glycol reduced graphene material.

Statement 53: The method of statement 52, further comprising: drying graphene oxide to form a dried graphene oxide with a moisture content of under 1 wt %; dispersing the dried graphene oxide in triethylene glycol by sonication to form a solution of graphene oxide in triethylene glycol; adding chitosan and thiourea to the solution of graphene oxide in triethylene glycol to form a mixture of chitosan, thiourea, and graphene oxide in triethylene glycol; adjusting pH of the mixture to between 9 and 10; heating the mixture to a temperature in an inert atmosphere for a specified time to form a co-doped triethylene glycol reduced graphene solution; cooling the co-doped triethylene glycol reduced graphene solution; removing the co-doped triethylene glycol reduced graphene from the solution by diluting, centrifuging, and washing to form a co-doped triethylene glycol reduced graphene pellet; and drying the co-doped triethylene glycol reduced graphene pellet to obtain the co-doped triethylene glycol reduced graphene material.

Statement 54: The method of statement 53, wherein the temperature ranges from about 270° C. to about 285° C.

Statement 55: The method of statement 45, wherein the binder material comprises chitosan, alginate, cellulose derivatives, polyvinyl alcohol (PVA), carboxymethyl cellulose (CMC), or polyacrylic acid (PAA).

Statement 56: The method of statement 45, wherein the current collector material comprises aluminum, copper, stainless steel, or nickel.

Statement 57: The method of statement 45, the specified thickness ranges from between about 150 μm to about 250 μm.

Statement 58: The method of statement 45, the specified density ranges from between about 1.4 g/cm³ to about 1.8 g/cm³.

Statement 59: The method of statement 45, wherein the cutting tool comprises a disc cutter, punching tools, laser cutting, water jet cutting, or mechanical cutting tools including but not limited to rotary cutters or precision blades.

Statement 60: The method of statement 45, wherein reducing the graphene oxide to graphene and incorporation of dopants into the graphene occurs simultaneously.

Statement 61: The battery of any one of statements 32-44, wherein the battery is a coin cell battery.

Statement 62: The battery of statement 61, wherein the voltage is ≥4.3 V, ≥4.2 V, ≥4.1 V, ≥4.0 V, ≥3.9 V, ≥3.8 V, or ≥3.7 V.

Statement 63: The battery of statement 61, wherein the voltage is higher than a 3.6 V lithium-ion coin cell battery.

Statement 64: The battery of statement 61, wherein the battery comprises a 68-169% increase in energy density compared to a 3.6 V lithium-ion coin cell battery.

Statement 65: The battery of statement 61, wherein the battery comprises a capacity of ≥35 mAh, ≥36 mAh, ≥37 mAh, ≥38 mAh, ≥39 mAh, ≥40 mAh, ≥41 mAh, ≥42 mAh, ≥43 mAh, ≥44 mAh, ≥45 mAh, ≥46 mAh, ≥47 mAh, ≥49 mAh, or ≥50 mAh.

Statement 66: The battery of statement 61, wherein the battery comprises a capacity from about 35 mAh to about 50 mAh.

Statement 67: An electrode material comprising graphene, a plurality of dopants, and interconnected porous structures comprising a plurality of pores.

Statement 68: The battery of statement 67, wherein the graphene is a polyol reduced graphene.

Statement 69: The battery of statement 67, further comprising an electrolyte.

Statement 70: The battery of statement 69, wherein the electrolyte is an ionic liquid.

Statement 71: The battery of statement 70, wherein the ionic liquid comprises 1-butyl-1-methylpyrrolidinium bis(trifluoromethylsulfonyl)imide.

Statement 72: The battery of statement 67, wherein the battery further comprises one or more additives.

Statement 73: The battery of statement 72, wherein the one or more additives comprises a salt additive, a non-salt additive, or a combination thereof.

Statement 74: The battery of statement 73, wherein the non-salt additive comprises a carbonate additive, a sulfite additive, or a combination thereof.

Statement 75: The battery of statement 74, wherein the carbonate additive comprises fluoroethylene carbonate.

Statement 76: The battery of statement 73, wherein the sulfite additive comprises ethylene sulfite.

Statement 77: The battery of statement 73, wherein the salt additive comprises a lithium salt.

Statement 78: The battery of statement 77, wherein the lithium salt comprises lithium bis(trifluoromethanesulfonyl)imide (LiTFSI), lithium hexafluorophosphate (LiPF₆), or a combination thereof.

Statement 79: The battery of statement 72, wherein the one or more additives form a stable solid electrolyte interphase.

Statement 80: A battery comprising an anode and cathode, wherein the anode or the cathode comprise an electrode material comprising graphene and a plurality of dopants.

Statement 81: The battery of statement 80, further comprising a plurality of pores.

Statement 82: The battery of statement 81, wherein the plurality of pores are interconnected.

Statement 83: A battery comprising the cathode of claim 1,

Statement 84: The battery of statement 83, wherein the battery is a coin cell battery.

Statement 85: The battery of statement 83, wherein the voltage is ≥4.3 V, ≥4.2 V, ≥4.1 V, ≥4.0 V, ≥3.9 V, ≥3.8 V, or ≥3.7 V.

Statement 86: The battery of statement 83, wherein the voltage is higher than a 3.6 V lithium-ion coin cell battery.

Statement 87: The battery of statement 83, wherein the battery comprises a 68-169% increase in energy density compared to a 3.6 V lithium-ion coin cell battery.

Statement 88: The battery of statement 83, wherein the battery comprises a capacity of ≥35 mAh, ≥36 mAh, ≥37 mAh, ≥38 mAh, ≥39 mAh, ≥40 mAh, ≥41 mAh, ≥42 mAh, ≥43 mAh, ≥44 mAh, ≥45 mAh, ≥46 mAh, ≥47 mAh, ≥49 mAh, or ≥50 mAh.

Statement 89: The battery of statement 83, wherein the battery comprises a capacity from about 35 mAh to about 50 mAh.

Statement 90: The battery of statement 83, wherein battery further comprises a plurality of pores.

Statement 91: The battery of statement 90, wherein the plurality of pores are interconnected.

Statement 92: The battery of statement 83, wherein the battery comprises an electrolyte.

Statement 93: The battery of statement 92, wherein the electrolyte comprises an ionic liquid.

Statement 94: The battery of statement 92, wherein the electrolyte is an ionic liquid.

Statement 95: The battery of statement 93, wherein the ionic liquid comprises 1-butyl-1-methylpyrrolidinium bis(trifluoromethylsulfonyl)imide.

Statement 96: The battery of statement 83, wherein the battery further comprises one or more additives.

Statement 97: The battery of statement 96, wherein the one or more additives comprises a salt additive, a non-salt additive, or a combination thereof.

Statement 98: The battery of statement 97, wherein the non-salt additive comprises a carbonate additive, a sulfite additive, or a combination thereof.

Statement 99: The battery of statement 98, wherein the carbonate additive comprises fluoroethylene carbonate.

Statement 100: The battery of statement 98, wherein the sulfite additive comprises ethylene sulfite.

Statement 101: The battery of statement 97, wherein the salt additive comprises a lithium salt.

Statement 102: The battery of statement 101, wherein the lithium salt comprises lithium bis(trifluoromethanesulfonyl)imide (LiTFSI), lithium hexafluorophosphate (LiPF₆), or a combination thereof.

Statement 103: The battery of statement 96, wherein the one or more additives form a stable solid electrolyte interphase.

1. A cathode material comprising a polyol reduced graphene and a plurality of dopants.

2. The cathode material of claim 1, wherein the plurality of dopants is incorporated into the graphene.

3. The cathode material of claim 1, wherein the polyol comprises ethylene glycol, glycerol, triethylene glycol (TEG), or combinations thereof.

4. The cathode material of claim 3, wherein the polyol is triethylene glycol.

5. The cathode material of claim 1, wherein the plurality of dopants comprise nitrogen, sulfur, boron, phosphorous, iron, or a combination thereof.

6. The cathode material of claim 5, wherein the plurality of dopants is a co-dopant comprising nitrogen and sulfur.

7. The cathode material of claim 6, wherein the nitrogen is derived from a nitrogen containing polyvinyl alcohol, polyacrylic acid, or combinations thereof.

8. The cathode material of claim 7, wherein the nitrogen is derived from chitosan.

9. The cathode material of claim 6, wherein the sulfur is derived from thioacetamide, sodium sulfide, elemental sulfur, thiourea, or combinations thereof.

10. The cathode material of claim 1, wherein the cathode material formula is CₓHyO_{z}NₘSₙ,
wherein x, y, z, m, and n are integers or decimal numbers; where x is about 1 to about 10, y is about 1 to about 20, z is about 0 to about 5, m is greater than 0 to about 5, and n is greater than 0 to about 5.

11. The cathode material of claim 1, wherein the cathode material formula is CₓHyO_{z}NₘSₙ,
wherein x, y, z, m, and n are integers or decimal numbers; where x is about 2 to about 8, y is about 5 to about 15, z is about 2 to about 4, m is greater than 2 to about 4, and n is greater than 2 to about 4.

12. The cathode material of claim 1, wherein the cathode material formula is CₓH_{y}O_{z}NₘSₙ,
wherein x, y, z, m, and n are integers or decimal numbers; where x is about 4 to about 6, y is about 5 to about 15, z is about 2 to about 4, m is greater than 2 to about 4, and n is greater than 2 to about 4.

13. The cathode material of claim 1, wherein the cathode material formula is CₓH_{y}O_{z}NₘSₙ,
wherein x, y, z, m, and n are integers or decimal numbers; where x is about 2 to about 8, y is about 10 to about 12, z is about 2 to about 4, m is greater than 2 to about 4, and n is greater than 2 to about 4.

14. The cathode material of claim 10, wherein the formula is C₆H₄N₂S or C₅H₁₀ O₃N₃S₃.

15. The cathode material of claim 10, wherein nitrogen to sulfur atomic ratio (N/S) is varied to optimize electrochemical performance of the cathode material in energy storage applications.

16. The cathode material of claim 15, wherein the N/S ratio ranges from about 1:1 to about 3:1.

17. The cathode material of claim 1, wherein cathode material of has a specific capacity ranging from between 200 mAh/g to 750 mAh/g.

18. The cathode material of claim 17, wherein cathode material of has a specific capacity ranging from between 280 mAh/g to 450 mAh/g.

19. The cathode material of claim 17, wherein cathode material of has a specific capacity ranging from between 350 mAh/g to 600 mAh/g.

20. The cathode material of claim 17, wherein cathode material of has a specific capacity ranging from between 420 mAH/g to 750 mAh/g.

21. The cathode material of claim 17, wherein the cathode material has a specific capacity ranging from between 200 to 300 mAh/g.

22. The cathode material of claim 1, wherein the cathode material has an energy density ranging from greater than 500 to 2500 Wh/kg.

23. The cathode material of claim 1, wherein the cathode material has an energy density ranging from 800 to 1500 Wh/kg.

24. The cathode material of claim 1, wherein the cathode material has an energy density ranging from 1000 to 2000 Wh/kg.

25. The cathode material of claim 1, wherein the cathode material has an energy density ranging from 1200 to 2500 Wh/kg.

26. The cathode material of claim 1, wherein the cathode material has an energy density ranging from 600 to 800 Wh/kg.

27. The cathode material of claim 1, wherein the cathode material has an energy density ranging from 510 to 700 Wh/kg.

28. A battery comprising the cathode material of claim 1.

29. A battery comprising the cathode material of claim 17.

30. A composition comprising a graphene doped with nitrogen and sulfur.
